(19) United States
(12) Patent Application Publication
(10) Pub. No.: US 2013/0154883 A1
(43) Pub. Date: Jun. 20, 2013

(54) POSITIONING ERROR CALCULATION DEVICE, POSITIONING ERROR CALCULATION SYSTEM AND POSITIONING ERROR CALCULATION METHOD

(71) Applicant: Shoji Ogura, Tokyo (JP)

(72) Inventor: Shoji Ogura, Tokyo (JP)

(73) Assignee: NEC CORPORATION, Tokyo (JP)

(21) Appl. No.: 13/806,387

(22) PCT Filed: Jun. 16, 2011
(86) PCT No.: PCT/JP11/64326

§ 371 Date: Dec. 21, 2012

(30) Foreign Application Priority Data
Jun. 22, 2010 (JP) 2010-141339

(51) Int. Cl. G01S 5/14

(52) U.S. Cl. CPC G01S 5/14
USPC 342/451

(57) ABSTRACT

Provided is a positioning error calculation device which enables provision of an appropriate positioning error value regarding position data obtained by base-station positioning regardless of the position where a positioning target exists. The positioning error calculation device includes: an element which stores therein positioning record information including first positioning result information corresponding to a position of a terminal device; an element which selects and acquires the positioning record information; an element which calculates a density of positioning records at each of predetermined places on the basis of the positioning record information; an element which calculates an estimated positioning error value by using a relational expression, on the basis of the density; and an element which acquires the estimated positioning error value at each of the places by acquiring the estimated positioning error value corresponding to the density at the each of the places.

### TECHNICAL FIELD

The present invention relates to positioning error calculation devices, positioning error calculation systems and positioning error calculation methods, and in particular, it relates to a positioning error calculation device, a positioning error calculation system and a positioning error calculation method in a range-based position detection.

### BACKGROUND ART

Recently, with the sophistication of mobile terminals, there have been provided various services based on position information. Known examples of the sophistication of mobile terminals include constantly running or periodically running of applications, positioning functions utilizing the global positioning system (GPS) and the like.

In services based on position information, which are provided by mobile terminals, it is important to suppress power consumption for positioning processing in a mobile terminal. At the same time, it is important to satisfy positioning accuracy required by applications which execute the services.

Positioning methods mainly employed by mobile terminals, such as mobile telephones, are, for example, GPS positioning and base-station positioning.

The GPS positioning is a positioning method performed by receiving radio waves from a plurality of satellites. The GPS positioning has an advantage of having high positioning accuracy. However, the GPS positioning needs a continuous acquisition of feeble radio waves transmitted from the plurality of satellites during a constant period of time. Therefore, the GPS positioning has a disadvantage in that the environment under which positioning can operate is restricted. Further, the GPS positioning needs a long positioning duration and a long calculation duration. This leads to a disadvantage in that the GPS positioning incurs large power consumption.

Meanwhile, the base-station positioning employs the received signal strength indication (RSSI) method, which is one of the range-based position detection technologies. That is, the base-station positioning estimates the position of a mobile terminal (a mobile station) from positioning information including the radio field intensity of radio waves from a base station with which the mobile terminal communicates, and the position of the base station. In the base-station positioning, under the situation where communication with a base station can be performed, positioning is available. Moreover, in the base-station positioning, there is an advantage in that power consumption therefor is small. However, the base-station positioning has a disadvantage in that, sometimes, positioning accuracy is low (a positioning error is large).

An example of the technologies for calculating a positioning error, which are needed to perform effective positioning, is described in each of PTL 1 and PTL 2 listed below.

An automatic machinery control system disclosed in PTL 1 listed below has a control computer including a Karman filter. This Karman filter receives an absolute measurement value or an absolute position from a supply source supported thereby, and a current position from an inertial navigation system. Next, this Karman filter transmits an estimated error value to the inertial navigation system on the basis of a difference between a set of these two positions or measurement values. The inertial navigation system makes an appropriate change to the position from the inertial navigation system by using this estimated error value.

A position server disclosed in PTL 2 listed below calculates, as an uncertain area, a portion overlapped by spheres which situate centers thereof at respective positions of a terminal, having been measured from a plurality of position coordinates, and which have radiuses equal to respective predetermined distance error values. Subsequently, this position server calculates, for example, a center-of-gravity of the uncertain area as the position of the terminal. Further, this position server calculates, for example, the radius of the circumscribed sphere of the uncertain area as an index for evaluation of the uncertainty of the position of the terminal.

### PATENT LITERATURE

[PTL 1] Japanese Patent Application Publication No. 2008-164590
[PTL 2] Japanese Patent Application Publication No. 2003-075526

### SUMMARY OF THE INVENTION

### Problem to be Solved by the Invention

However, in the technologies disclosed in the above-described pieces of patent literature, there is a problem that, depending on the position where a positioning target exists, sometimes, a positioning error value, which results from determination from predetermined positioning accuracy provided for position data obtained by base-station positioning, is not appropriate.

A reason why, sometimes, the positioning error value is not appropriate is as follows. The acquisition of positioning information which is a basis of the base-station positioning is sometimes unstable being affected by external environment. Thus, an error value determined from predetermined positioning accuracy having been theoretically or empirically derived is sometimes different from a positioning error value regarding position data resulting from calculation based on such positioning information.

An object of the present invention is to provide a positioning error calculation device, a positioning error calculation system and a positioning error calculation method which enable solution of the technical problem described above.

### Means for Solving a Problem

A positioning error calculation device according to a first aspect of the present invention includes: a first positioning record storage means which stores therein first positioning record information including first positioning result information corresponding to a position of a terminal device, having been estimated by a first positioning means;

a record selection means which selects and acquires the first positioning record information from the first positioning record storage means;

a positioning record density calculation means which calculates a density of positioning records at each of predetermined places on the basis of the first positioning record information having been acquired by the record selection means;

a density and positioning error calculation means which calculates an estimated positioning error value on the basis of the density having been calculated by the positioning record density calculation means; and

a position and positioning error calculation means which acquires the estimated positioning error value at each of the places by acquiring the estimated positioning error value corresponding to the density from the density and positioning error calculation means on the basis of the density at the each of the places, having been calculated by the positioning record density calculation means.

A positioning error calculation method according to a second aspect of the present invention includes:

storing first positioning result information corresponding to a position of a terminal device, which has been measured by a first positioning means, into a first positioning record storage means;

selecting and acquiring the first positioning record information from the first positioning record storage means;

calculating a density of positioning records at each of predetermined places on the basis of the first positioning record information having been acquired;

calculating an estimated positioning error value on the basis of the density having been calculated; and

acquiring the estimated positioning error value at each of the places by acquiring the estimated positioning error value corresponding to the density on the basis of the density at the each of the places, having been calculated.

A positioning error calculation program recorded in a non-transitory medium according to a third aspect of the present invention causes a computer to execute processing includes:

a process of selecting and acquiring first positioning record information conforming to a predetermined condition from among first positioning result information which is stored in first positioning record storage means, and which corresponds to a position of a terminal device, having been measured by a first positioning means;

a process of calculating a density of positioning records at each of predetermined places on the basis of the first positioning record information having been acquired;

a process of calculating an estimated positioning error value on the basis of the density having been calculated; and

a process of acquiring the estimated positioning error value at each of the places by acquiring the estimated positioning error value corresponding to the density on the basis of the density at the each of the places, having been calculated.

### Effect of the Invention

The present invention has an advantageous effect in that, regardless of a position where a positioning target exists, it is possible to provide an appropriate positioning error value regarding position data obtained by base-station positioning.

### BRIEF DESCRIPTION OF THE DRAWINGS

FIG. 1 is a block diagram illustrating a configuration of a first exemplary embodiment according to the present invention.

FIG. 2 is a diagram illustrating a data format of a positioning result according to a first exemplary embodiment of the present invention.

FIG. 3 is a diagram illustrating a data format of positioning result information according to a first exemplary embodiment of the present invention.

FIG. 4 is a diagram illustrating an example of a positioning density table according to a first exemplary embodiment of the present invention.

FIG. 5 is a diagram illustrating an example of a position and positioning error table according to a first exemplary embodiment of the present invention.

FIG. 6 is a flowchart illustrating operations for accumulating positioning record information, according to a first exemplary embodiment of the present invention.

FIG. 7 is a flowchart illustrating operations for calculating an estimated positioning error value at each place, according to a first exemplary embodiment of the present invention.

FIG. 8 is a block diagram illustrating a configuration of a second exemplary embodiment according to the present invention.

FIG. 9 is a diagram illustrating a data format of a high-accuracy positioning result according to a second exemplary embodiment of the present invention.

FIG. 10 is a diagram illustrating a data format of high-accuracy positioning result information according to second and third exemplary embodiments of the present invention.

FIG. 11 is a diagram illustrating a data format of a high-accuracy positioning result according to a second exemplary embodiment of the present invention.

FIG. 12 is a diagram illustrating a data format of high-accuracy positioning result information according to a second exemplary embodiment of the present invention.

FIG. 13 is a flowchart illustrating operations of a terminal device side in a positioning phase, according to a second exemplary embodiment of the present invention.

FIG. 14 is a flowchart illustrating operations of a positioning error calculation device side in a positioning phase, according to a second exemplary embodiment of the present invention.

FIG. 15 is a flowchart illustrating operations of a density and positioning error function phase, according to a second exemplary embodiment of the present invention.

FIG. 16 is a block diagram illustrating a configuration of a third exemplary embodiment according to the present invention.

FIG. 17 is a diagram illustrating an example of a base-station positioning result information table according to a third exemplary embodiment of the present invention.

FIG. 18 is a diagram illustrating an example of a high-accuracy positioning result information table according to a third exemplary embodiment of the present invention.

FIG. 19 is a diagram schematically illustrating a relation among an area mesh, an area-mesh code and a positioning record density ρ, according to a third exemplary embodiment of the present invention.

FIG. 20 is a block diagram illustrating a configuration of a fourth exemplary embodiment according to the present invention.

FIG. 21 is a block diagram illustrating a configuration of a server which causes a computer to execute predetermined processing by using a program, according to a third exemplary embodiment of the present invention.

### EXEMPLARY EMBODIMENTS FOR CARRYING OUT OF THE INVENTION

Next, exemplary embodiments according to the present invention will be described in detail with reference to the drawings.

### First Exemplary Embodiment

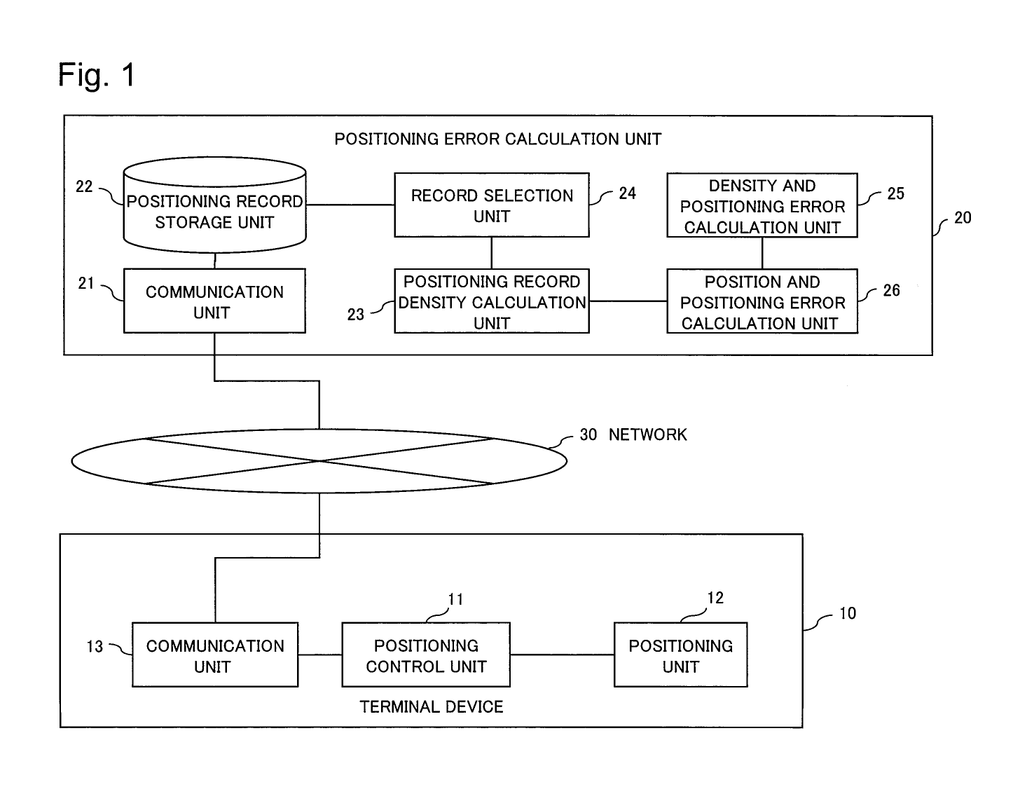

FIG. 1 is a block diagram illustrating an example of the configuration of a positioning error calculation system according to a first exemplary embodiment of the present invention. Referring to FIG. 1, the first exemplary embodiment includes a terminal device 10 and a positioning error calculation device 20. In addition, the terminal device 10 and the positioning error calculation device 20 are connected to each other via, for example, a network 30.

The terminal device 10 is, for example, a mobile telephone, a portable game machine, a navigation device or a portable computer. The terminal device 10 includes a positioning control unit 11, a positioning unit (also referred to as a first positioning means) 12 and a communication unit 13.

Each of these units may be constituted by a computer including a CPU (also referred to as a central processing unit, a processor, a data processor or the like) and a storage medium. In this case, the storage medium may store a program therein which causes the computer to execute corresponding processing described below. In addition, the storage medium may be a non-transitory storage medium.

The positioning control unit 11 performs timing control of positioning. For example, the positioning control unit 11 transmits a positioning command to the positioning unit 12 at intervals of a constant period of time, referring to a time-of-day device (not illustrated) incorporated in the terminal device 10. Further, for example, the positioning control unit 11 transmits a positioning command to the positioning unit 12 on the basis of a command for carrying out positioning, having been received from an outside.

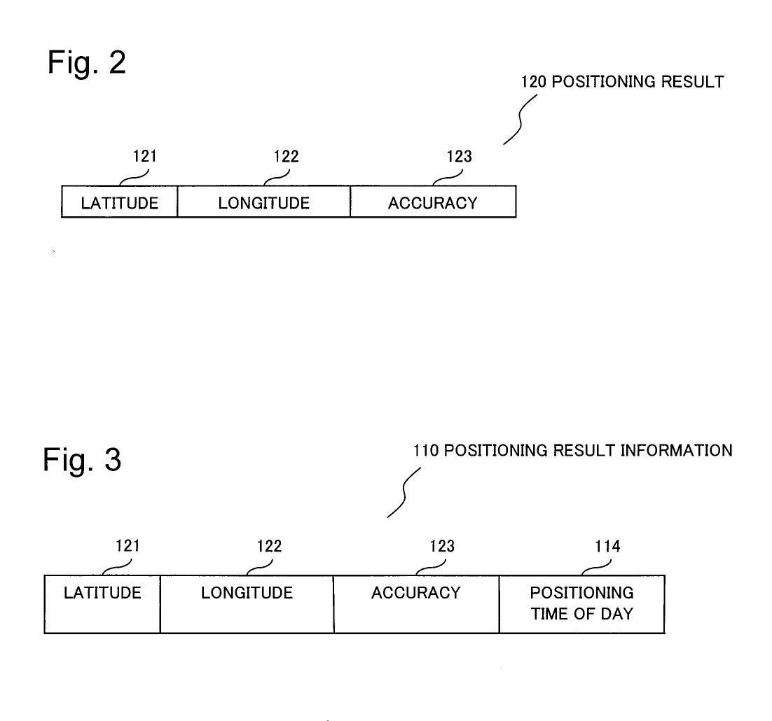

Further, the positioning control unit 11 transmits positioning result information (also referred to as first positioning result information) 110 to the communication unit 13, the positioning result information 110 being information resulting from addition of a positioning time of day 114 shown in FIG. 3 to a positioning result 120 shown in FIG. 2, having been received from the positioning unit 12.

FIG. 2 is a diagram illustrating a data format of the positioning result 120 according to this exemplary embodiment. As shown in FIG. 2, the positioning result 120 includes a latitude 121, a longitude 122 and an accuracy 123. In addition, the accuracy 123 is, for example, predetermined positioning accuracy which has been received from a base station during positioning processing, and which has been theoretically or empirically derived.

FIG. 3 is a diagram illustrating a data format of the positioning result information 110 according to this exemplary embodiment. As shown in FIG. 3, the positioning result information 110 includes the latitude 121, the longitude 122, the accuracy 123 and the positioning time of day 114.

Upon reception of a positioning command, the positioning unit 12 communicates with one or more radio base stations (not illustrated). Next, the positioning unit 12 calculates the latitude 121, the longitude 122 and the accuracy 123 (which indicates an error range of these latitude and longitude) of the terminal device 10 on the basis of the states of the communications. Further, the positioning unit 12 transmits the calculated information, that is, the latitude 121, the longitude 122 and the accuracy 123, to the positioning control unit 11 as the positioning result 120.

In addition, generally, positioning using radio base stations in a terminal device is performed by using position information regarding predetermined radio base stations, and distances between the radio base stations and the terminal device, which are calculated on the basis of the radio field intensities of radio waves having been received from the radio base stations.

The communication unit 13 communicates with the positioning error calculation device 20 via the network 30, and thereby transmits the positioning result information 110 to the positioning error calculation device 20. In addition, the communication unit 13 may be, for example, a data communication unit provided in a mobile telephone.

The positioning error calculation device 20 is, for example, a server, a computer system, a personal computer or the like. The positioning error calculation device 20 includes a communication unit 21, a positioning record storage unit (also referred to as a first positioning record storage means) 22, a positioning record density calculation unit 23, a record selection unit 24, a density and positioning error calculation unit 25 and a position and positioning error calculation unit 26.

Each of these units may be constituted by a computer including a CPU and a storage medium. In this case, the storage medium may store a program therein which causes the computer to execute corresponding processing described below. In addition, the storage medium may be a non-transitory storage medium.

The communication unit 21 receives the positioning result information 110 from the terminal device 10 through the network 30, and transmits this information to the positioning record storage unit 22.

The positioning record storage unit 22 accumulates the positioning result information 110 having been received from the communication unit 21 together with additional information (for example, a user identifier and the like) as positioning record information. The positioning record storage unit 22 is, for example, a relational database for accumulating a plurality pieces of positioning record information.

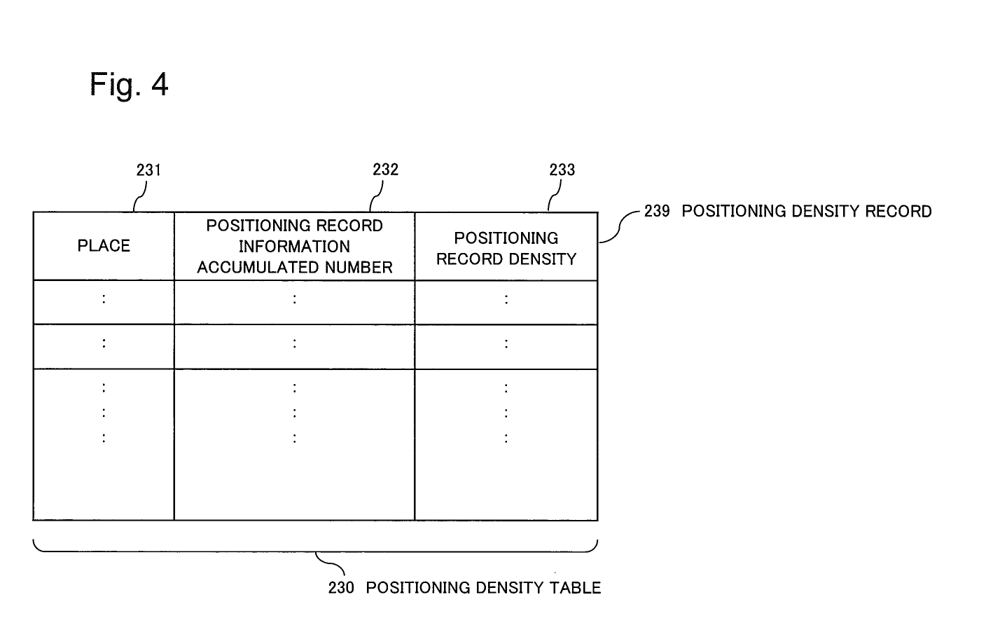

The positioning record density calculation unit 23 starts processing for calculating a positioning record density at each place on the basis of the positioning record information, the processing being performed at fixed intervals or in accordance with a command from an administrator or the like. The positioning record density calculation unit 23 creates a positioning density table 230 shown in FIG. 4, and stores it therein. FIG. 4 is a diagram illustrating a data format of the positioning density table 230. Referring to FIG. 4, the positioning density table 230 has at least one positioning density record 239 including a place 231, a positioning record information accumulated number 232 and a positioning record density 233. Here, the place 231 is a piece of data which is determined (or sorted) on the basis of the latitude 141 and the longitude 142 included in the acquired positioning recording information 110. In this patent description, the place 231 indicates a geographically specified range region including the latitude 141 and the longitude 142 (for example, a range region bounded by the latitudes of North 35 degrees 41 minutes 22 seconds and North 35 degrees 41 minutes 23 seconds, and the longitudes of East 139 degrees 41 minutes 30 seconds and East 139 degrees 41 minutes 31 seconds).

The positioning record density calculation unit 23 requests the record selection unit 24 to acquire positioning record information by indicating a selection condition for the positioning recording information to be acquired. Next, the positioning record density calculation unit 23 receives positioning record information which the record selection unit 24 has acquired in response to the request.

The selection condition for positioning record information to be acquired by the positioning record density calculation unit 23 is different depending on the definition of the positioning record density 233. For example, in the case where the positioning record density 233 is defined as the number of positioning records having been recorded during a predetermined fixed period, the selection condition is such that positioning record information having been recorded during the predetermined fixed period is to be selected. The predetermined fixed period is, for example, a period of one week or the like backward from the time when the acquisition of positioning record means has been requested.

The positioning record density calculation unit 23 sorts each piece of the positioning record information into the corresponding one of the places 231 on the basis of the latitude 121 and the longitude 122 included in the each of the positioning record information. Further, the positioning record density calculation unit 23 calculates, for each of the places 231, the positioning record information accumulated number 232 regarding positioning record information having been recorded during the predetermined fixed period. Next, the positioning record density calculation unit 23 creates the positioning record density 233 corresponding to each of the places 231 on the basis of the calculated positioning record information accumulated number 232. For example, the positioning record density calculation unit 23 calculates the number of positioning record information per a unit area as the positioning record density 233. Further, the positioning record density calculation unit 23 stores a set of the positioning density records 239, in each of which the place 231, the positioning record information accumulated number 232 and the positioning record density 233 are correlated with one another, into its internal memory module (not illustrated) as the positioning density table 230. Moreover, the positioning record density calculation unit 23 transmits the created positioning record densities 233 to the position and positioning error calculation unit 26.

The record selection unit 24 receives a request from the positioning record density calculation unit 23. Next, the record selection unit 24 acquires positioning record information from the positioning record storage unit 22 on the basis of a selection condition having been specified by the positioning record density calculation unit 23. Specifically, for example, on the basis of a specification of the start and end times of a record-time range, the specification being included in the request from the positioning record density calculation unit 23, the record selection unit 24 selects positioning record information having a record time falling within the record-time range. The record selection unit 24 transmits the selected positioning record information to the positioning record density calculation unit 23.

The density and positioning error calculation unit 25 creates the estimated positioning error value 264 corresponding to the positioning record density 233.

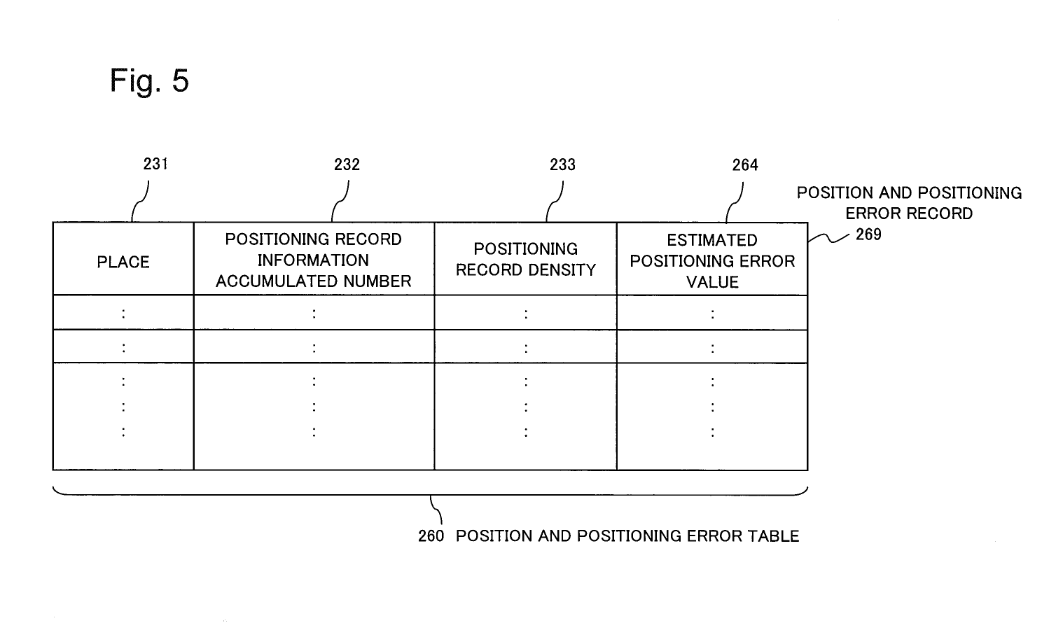

The density and positioning error calculation unit 25 receives a density and positioning error calculation request, which includes the positioning record density 233, from the position and positioning error calculation unit 26. Further, the density and positioning error calculation unit 25 converts the positioning record density 233, which is included in the received density and positioning error calculation request, in accordance with a predetermined relational expression, and thereby creates the estimated positioning error value 264 (refer to a description below with reference to FIG. 5). Further, the density and positioning error calculation unit 25 transmits the created estimated positioning error value 264 to the position and positioning error calculation unit 26. In addition, the predetermined relational expression is, for example, an expression described below, which is represented by an approximation function whose basis function is a linear function.

Estimated positioning error value=a×Positioning record density+b

(The ‘a’ and ‘b’ are constant numbers having been empirically derived in advance)

The expression described above is, for example, a relational expression which is obtained by arranging a plurality of measured sample values of the positioning error and the positioning record density on a plane coordinate, and deriving the basis function and the ‘a’ and ‘b’ to be constant values from a correlation among the sample values.

In addition, the basis function may be also a quadratic function, a logarithmic function or the like, and it is empirically or theoretically determined in advance which one of established functions is to be used.

The position and positioning error calculation unit 26 acquires the estimated positioning error values 264 at the respective places 231 on the basis of the positioning record density 233 at the respective places 231. Specifically, first, as described above, the positioning record densities 233 which the position and positioning error calculation unit 26 has received from the positioning record density calculation unit 23 are the positioning record densities 233 at the respective places 231. Therefore, the position and positioning error calculation unit 26 transmits a density and positioning error calculation request including the positioning record density 233 at certain one of the places 231 to the density and positioning error calculation unit 25. Next, the position and positioning error calculation unit 26 receives the estimated positioning error value 264 as a response thereto. In this way, the position and positioning error calculation unit 26 acquires the estimated positioning error value 264 corresponding to the certain one of the places 231.

The position and positioning error calculation unit 26 executes the above-described processing on the positioning record density 233 corresponding to each of all the places 231. In this way, the position and positioning error calculation unit 26 acquires the estimated positioning error values 264 at the respective places 231. The acquired estimated positioning error values 264 at the respective places 231 are outputted to an error correction circuit (not illustrated) from the position and positioning error calculation unit 26. The outputted estimated positioning error values 264 at the respective places 231 are used for the correction of errors, or the like, in the operation of positioning.

FIG. 5 is a diagram illustrating a data format of the position and positioning error table 260. Referring to FIG. 5, the position and positioning error table 260 has at least one position and positioning error record 269 including the place 231, the positioning record information accumulated number 232, the positioning record density 233 and the estimated positioning error value 264.

The position and positioning error calculation unit 26 stores a set of the position and positioning error table records 269, in each of which the place 231, the positioning record information accumulated number 232, the positioning record density 233 and the estimated positioning error value 264 are correlated with one another, into its internal memory module (not illustrated) as the position and positioning error table 260.

Next, the operations of this exemplary embodiment will be described in detail with reference to FIGS. 1 to 7.

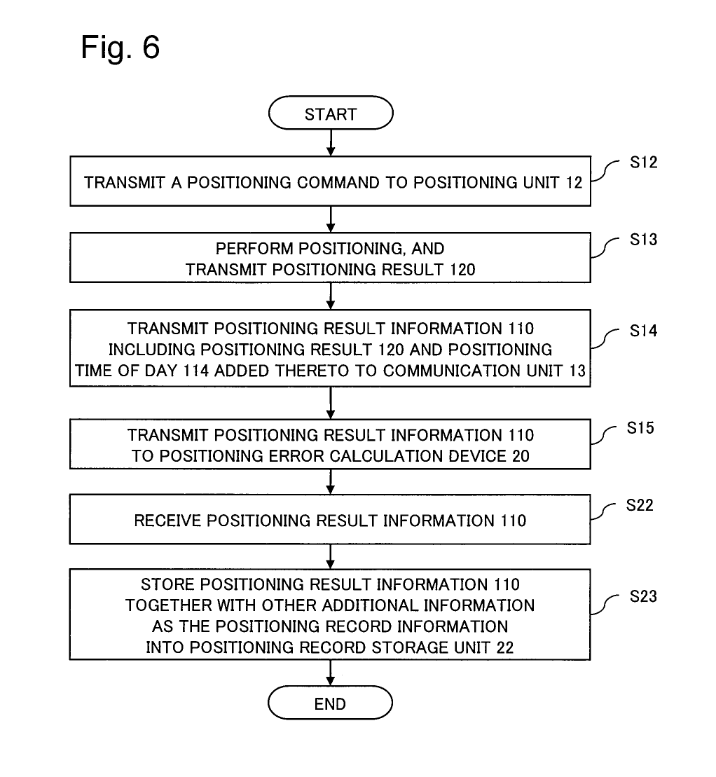

FIG. 6 is a flowchart illustrating operations for storing positioning record information, according to this exemplary embodiment.

First, the positioning control unit 11 transmits a positioning command to the positioning unit 12 (step S12).

Next, when having received the positioning command, triggered by this command, the positioning unit 12 communicates with radio base stations, and thereby performs positioning. Subsequently, the positioning unit 12 transmits the positioning result 120 including the latitude 121, the longitude 122 and the accuracy 123 to the positioning control unit 11 (step S13).

Next, the positioning control unit 11 transmits the positioning result information 110, which includes the received positioning result 120 and the positioning time of day 114 added thereto, to the communication unit 13 (step S14).

Next, the communication unit 13 transmits the received positioning result information 110 to the positioning error calculation device 20 via the network 30 (step S15).

Next, the positioning error calculation device 20 receives the positioning result information 110 via the network 30 (step S22).

Next, the positioning error calculation device 20 stores the received positioning result information 110 into the positioning record storage unit 22 (step S23).

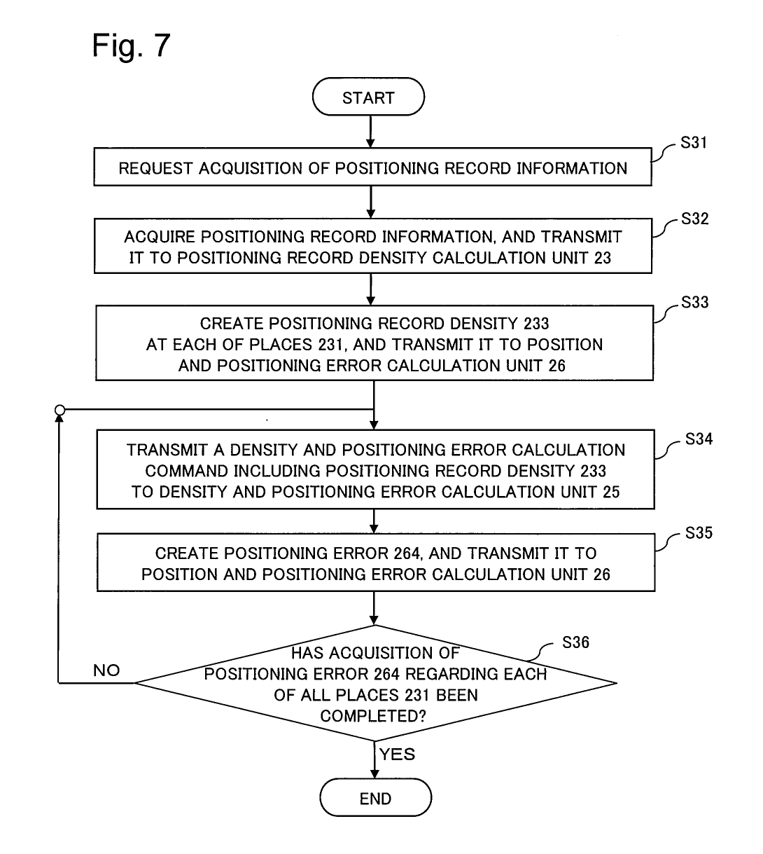

FIG. 7 is a flowchart illustrating operations for calculating the estimated positioning error values 264 at the respective places 231 on the basis of the accumulated positioning recording information, according to this exemplary embodiment.

First, the positioning record density calculation unit 23 requests the record selection unit 24 to acquire positioning record information by indicating a selection condition for the positioning recording information to be acquired (step S31).

Next, the record selection unit 24 acquires the positioning record information from the positioning record storage unit 22 on the basis of the selection condition having been specified by the positioning record density calculation unit 23, and transmits the acquired positioning record information to the positioning record density calculation unit 23 (step S32).

Next, the positioning record density calculation unit 23 creates the positioning record densities 233 at the respective places 231 on the basis of the received positioning record information, and transmits the created positioning record densities 233 to the position and positioning error calculation unit 26 (step S33). The positioning record density 233 is, for example, the number of pieces of positioning record information per a unit area, which is obtained by dividing the positioning record information accumulated number 232 at a certain one of the places 231 by the area of the certain one of the places 231 (i.e., the area of the above-described specified range region).

Next, the position and positioning error calculation unit 26 transmits a density and positioning error calculation request including the positioning record density 233 to the density and positioning error calculation unit 25 (step S34).

Next, the density and positioning error calculation unit 25 creates the estimated positioning error value 264 by converting the positioning record density 233 included in the received density and positioning error calculation request in accordance with a predetermined a relational expression. Next, the density and positioning error calculation unit 25 transmits the created estimated positioning error value 264 to the position and positioning error calculation unit 26 (step S35).

Next, the position and positioning error calculation unit 26 confirms whether the acquisition of the estimated positioning error value 264 has been completed regarding each of all the places 231, or not (step S36). If the acquisition thereof has been completed regarding each of all the places 231 (‘YES’ in step S36), the process flow terminates. If the acquisition thereof has not been completed regarding each of all the places 231 (‘NO’ in step S36), the process flow returns to step S34.

The advantageous effect of this exemplary embodiment described above is that, regardless of the position where a positioning target exists, it is possible to provide an appropriate positioning error value regarding position data obtained by base-station positioning.

The reason for this is that existing processing has been improved such that the following processes are involved. First, the positioning record density calculation unit 23 calculates the record densities at the respective places on the basis of the accumulated positioning record information. Next, the density and positioning error calculation unit 25 calculates the estimated positioning error values at the respective places from a correlation between the record density and the estimated positioning error value; thereby enabling improvement of existing processing.

In addition, examples of the above-described ‘situation in which the acquisition of positioning information from base stations is unstable’ include a situation in which the positioning result 120 to be transmitted to the positioning control unit 11 is calculated under the environment where detailed information related to positioning, such as position information and radio field intensities regarding the radio base stations, cannot be sufficiently acquired.

### Second Exemplary Embodiment

Next, a second exemplary embodiment according to the present invention will be described in detail with reference to the drawings. Hereinafter, contents overlapping with those of the description above will be omitted from description as far as the description of this exemplary embodiment does not become uncertain.

This second exemplary embodiment includes the function of deriving a relational expression between the positioning record density 233 and the estimated positioning error value 264, in addition to the functions of the first exemplary embodiment.

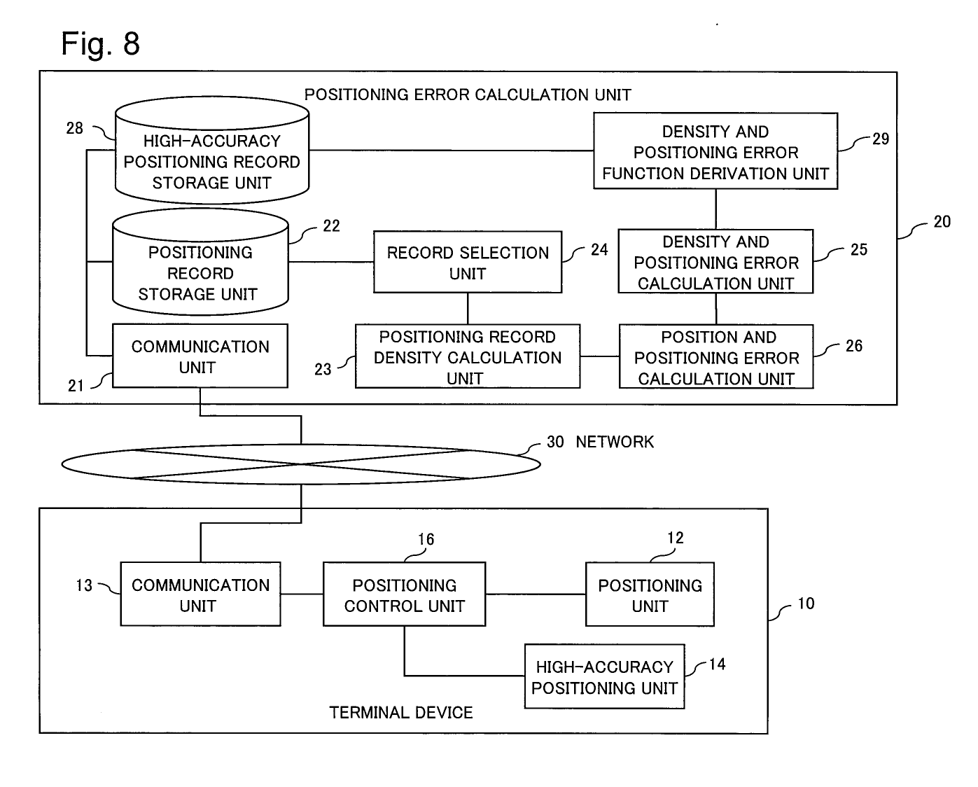

FIG. 8 is a block diagram illustrating a configuration of this exemplary embodiment. Referring to FIG. 8, in this exemplary embodiment, regarding the terminal device 10, as compared with the configuration of the first exemplary embodiment, a high-accuracy positioning unit (also referred to as a second positioning means) 14 is added, and the positioning control unit 11 is replaced by the positioning control unit 16. Moreover, in this exemplary embodiment, regarding the positioning error calculation device 20, as compared with the configuration of the first exemplary embodiment, a high-accuracy positioning record storage unit (also referred to as a second positioning record storage means) 28 and a density and positioning error function derivation unit (also referred to as a density and positioning error relational expression derivation means) 29 are added.

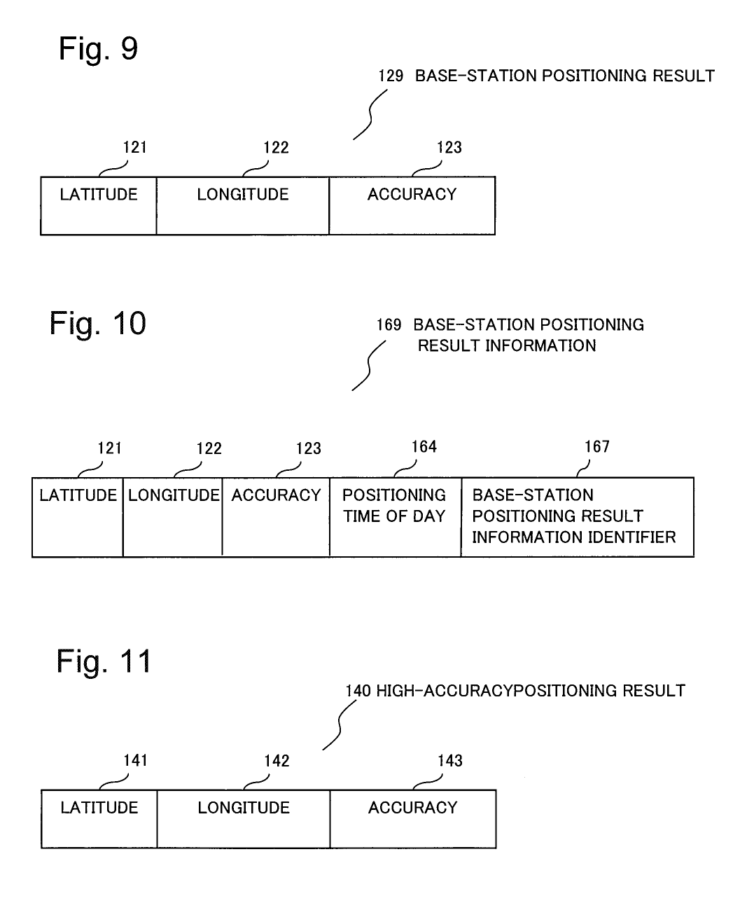

In addition, in the following description, the positioning result 120 acquired by the positioning unit 12 will be referred to as a base-station positioning result 129 shown in FIG. 9. Further, the positioning result information (the first positioning result information) 110 including the base-station positioning result 129 will be referred to as base-station positioning result information 169 shown in FIG. 10. Moreover, positioning record information including the base-station positioning result information 169 will be referred to as base-station positioning record information.

FIG. 9 is a diagram illustrating a data format of the base-station positioning result 129 according to this exemplary embodiment. As shown in FIG. 9, the base-station positioning result 129 includes the latitude 121, the longitude 122 and the accuracy 123.

FIG. 10 is a diagram illustrating a data format of the base-station positioning result information 169 according to this exemplary embodiment. As shown in FIG. 10, the base-station positioning result information 169 includes the latitude 121, the longitude 122, the accuracy 123, a positioning time of day 164 and a base-station positioning result information identification 167.

The positioning control unit 16 creates the base-station positioning result information 169 including the positioning time of day 164 and the base-station positioning result information identification 167 for identifying the base-station positioning result information 169, which are added to the base-station positioning result 129 having been received from the positioning unit 12. Next, the positioning control unit 16 transmits the created base-station positioning result information 169 to the communication unit 13.

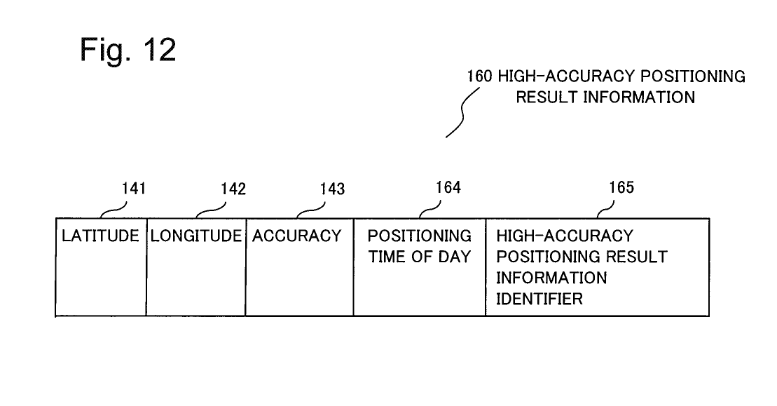

Further, the positioning control unit 16 creates high-accuracy positioning result information (also referred to as second positioning result information) 160, shown in FIG. 12, including the positioning time of day 164 and a high-accuracy positioning result information identifier 165 which are added to the high-accuracy positioning result 140, shown in FIG. 11, having been received from the high-accuracy positioning unit 14. Next, the positioning control unit 16 transmits the created high-accuracy positioning result information 160 to the communication unit 13. The high-accuracy positioning result information identifier 165 is an identifier for identifying the high-accuracy positioning result information 160.

FIG. 11 is a diagram illustrating a data format of the high-accuracy positioning result 140 according to this exemplary embodiment. As shown in FIG. 11, the high-accuracy positioning result 140 includes a latitude 141, a longitude 142 and an accuracy 143.

FIG. 12 is a diagram illustrating a data format of the high-accuracy positioning result information 160 according to this exemplary embodiment. As shown in FIG. 12, the base-station positioning result information 169 includes the latitude 141, the longitude 142, the accuracy 124, the positioning time of day 164 and the high-accuracy positioning result information identifier 165 for identifying the base-station positioning result information 169.

The high-accuracy positioning unit 14 is a positioning means capable of performing positioning more accurately than the positioning unit 12, and performs positioning utilizing, for example, the GPS. The high-accuracy positioning unit 14 performs positioning on the basis of a positioning command having been received from the positioning control unit 16, just like the positioning unit 12. Further, the high-accuracy positioning unit 14 calculates the latitude 141, the longitude 142 and the accuracy 143, just like the positioning unit 12. Moreover, the high-accuracy positioning unit 14 transmits the latitude 141, the longitude 142 and the accuracy 143 resulting from the calculation to the positioning control unit 16 as the high-accuracy positioning result 140.

In addition, the positioning unit 12 and the high-accuracy positioning unit 14 perform positioning during the same period on the basis of respective positioning commands having been received from the positioning control unit 16. Therefore, the positioning control unit 16 adds the same positioning time of day 164 for the base-station positioning result information 169 and the high-accuracy positioning result information 160.

The high-accuracy positioning record storage unit 28 accumulates the high-accuracy positioning result information 160 having been received from the terminal device 10 via the communication unit 21 as high-accuracy positioning record information, together with other additional information (for example, user identifiers and the like). The high-accuracy positioning record storage unit 28 is, for example, a relational database for accumulating a plurality piece of the high-accuracy positioning record information.

The density and positioning error function derivation unit 29 derives a relational expression between the positioning record density 233 and the estimated positioning error value 264 on the basis of the high-accuracy positioning result information 160 and the base-station positioning result information 169.

In more detail, first, on the basis of a piece of high-accuracy positioning record information and a piece of base-station positioning record information which have the same positioning time of day 164 and the same user identifier, for each group including these pieces of information, the density and positioning error function derivation unit 29 calculates a difference between a position based on the base-station positioning result 129 and a position based on the high-accuracy positioning result 140. Subsequently, the density and positioning error function derivation unit 29 calculates a comparison positioning error on the basis of the calculated difference.

Next, the density and positioning error function derivation unit 29 creates a relational expression between the positioning record density 233 and the estimated positioning error value 264 on the basis of the plurality of calculated comparison positioning errors, and the positioning record densities 233 at the respective places 231 each including the position based on the high-accuracy positioning result 140 corresponding to the calculated comparison positioning error.

Supposing that it is attempted to, on the basis of groups of the high-accuracy positioning record information and the base-station positioning record information, derive a relational expression linking the corresponding estimated positioning error values 264 of the each places 231 from the places 231 and corresponding comparison positioning errors respectively, such a relational expression cannot be derived at particular ones of the places 231, at each of which the corresponding high-accuracy positioning record information does not exist. For this reason, the density and positioning error function derivation unit 29 derives a relational expression between the positioning record density 233 and the estimated positioning error value 264 on the basis of the calculated comparison positioning errors at the respective places 231 and the positioning record densities 233 at the respective places 231, which have been calculated by the positioning record density calculation unit 23. It is also possible to, by using this relational expression, acquire the estimated positioning error values 264 from the corresponding positioning record densities 233 regarding the particular ones of the places, at each of which the comparison positioning error cannot be obtained. That is, it is possible to link the particular ones of the places 231 and the estimated positioning error values 264 via the corresponding positioning record densities 233.

Next, the operations of this exemplary embodiment will be described in detail with reference to FIG. 4, FIG. 5 and FIGS. 8 to 15.

The operations of this exemplary embodiment is separated into a positioning phase for performing positioning, a positioning error calculation phase for calculating the estimated positioning error value 264 and a density and positioning error function deriving phase for deriving a relational expression between the positioning record density 233 and the estimated positioning error value 264. The operations of the positioning error calculation phase are the same as those of the first exemplary embodiment, and thus, detailed descriptions thereof will be omitted.

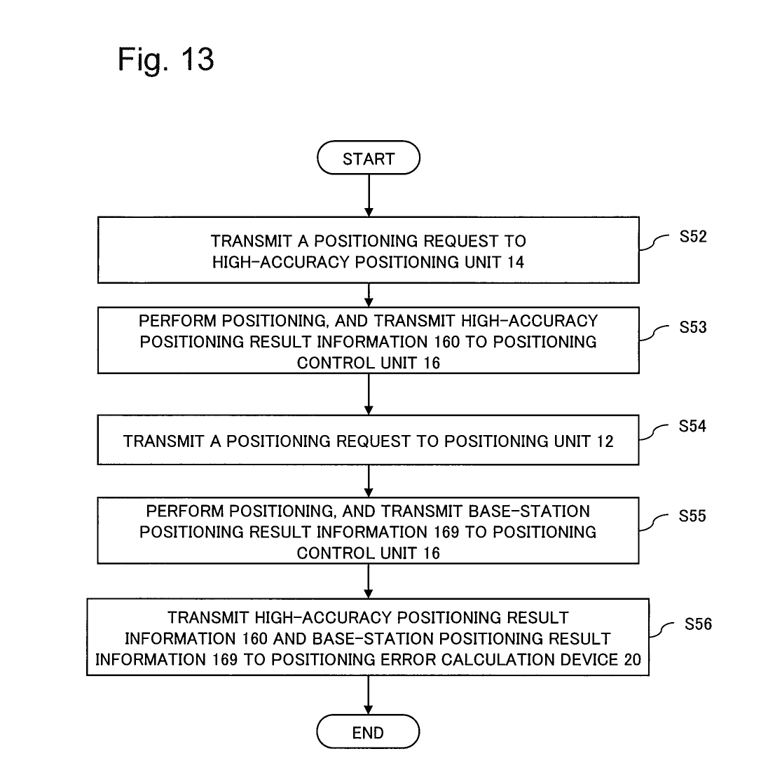

FIG. 13 is a flowchart illustrating operations of the terminal device 10 side during the positioning phase, according to this exemplary embodiment.

First,

First, the positioning control unit 16 transmits a positioning request to the high-accuracy positioning unit 14 (step S52).

Next, the high-accuracy positioning unit 14 performs positioning on the basis of the received positioning request, and transmits the high-accuracy positioning result information 160 to the positioning control unit 16 (step S53).

Next, the positioning control unit 16 transmits a positioning request to the positioning unit 12 (step S54).

Next, the positioning unit 12 performs positioning on the basis of the received positioning request, and transmits the base-station positioning result information 169 to the positioning control unit 16 (step S55).

Next, the positioning control unit 16 transmits the received high-accuracy positioning result information 160 and base-station positioning result information 169 to the positioning error calculation device 20 via the communication unit 13 (step S56). In addition, the positioning control unit 16 adds the positioning time of day 164 and the high-accuracy positioning result information identifier 165 to the high-accuracy positioning result information 160, and transmits the resultant information. Further, the positioning control unit 16 adds the positioning time of day 164 and base-station positioning result information identification 167 to the base-station positioning result information 169, and transmits the resultant information. The base-station positioning result information identification 167 is an identifier for identifying the base-station positioning result information 169.

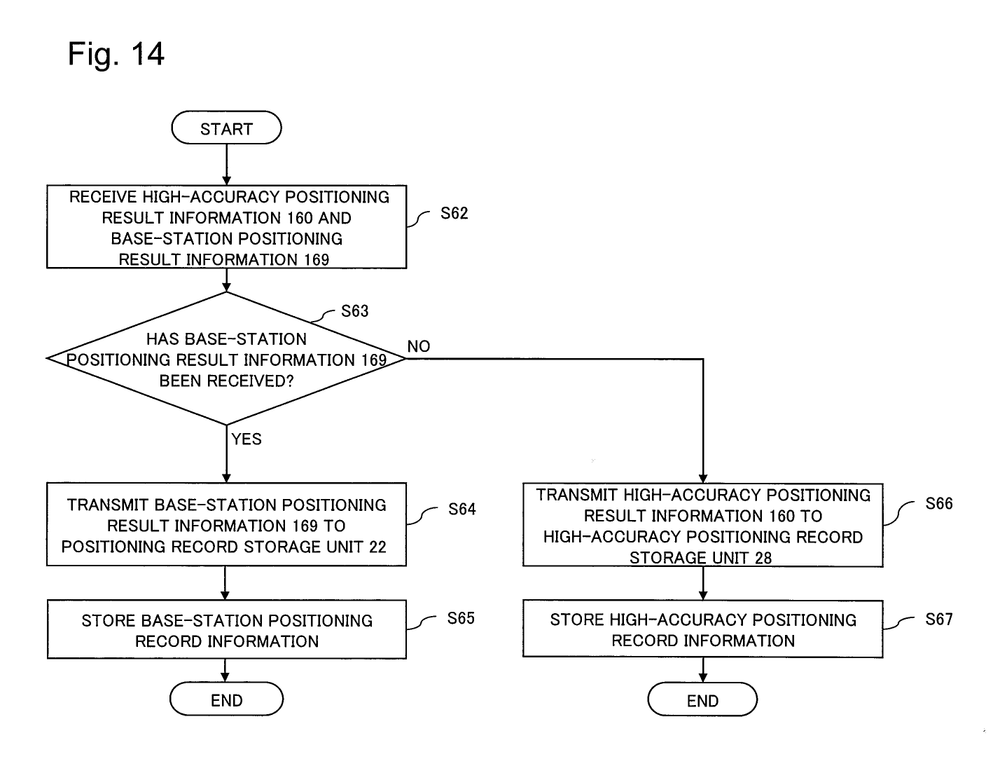

FIG. 14 is a flowchart illustrating operations of the positioning error calculation device 20 side during the positioning phase, according to this exemplary embodiment.

ep S61).

The communication unit 21 receives the high-accuracy positioning result information 160 and the base-station positioning result information 169 (step S62), and determines which of these kinds of information has been received (step S63). Further, if the base-station positioning result information 169 has been received (‘YES’ in step S63), the communication unit 21 transmits the base-station positioning result information 169 to the positioning record storage unit 22 (step S64). The positioning record storage unit 22, which has received the base-station positioning result information 169, stores this information therein as the base-station positioning record information (step S65).

Further, if the high-accuracy positioning result information 160 has been received (‘NO’ in step S63), the communication unit 21 transmits the high-accuracy positioning result information 160 to the high-accuracy positioning record storage unit 28 (step S66).

The high-accuracy positioning record storage unit 28, which has received the high-accuracy positioning result information 160, stores this information therein as the high-accuracy positioning record information (step S67).

With the completion of the above-described processes, the positioning phase terminates.

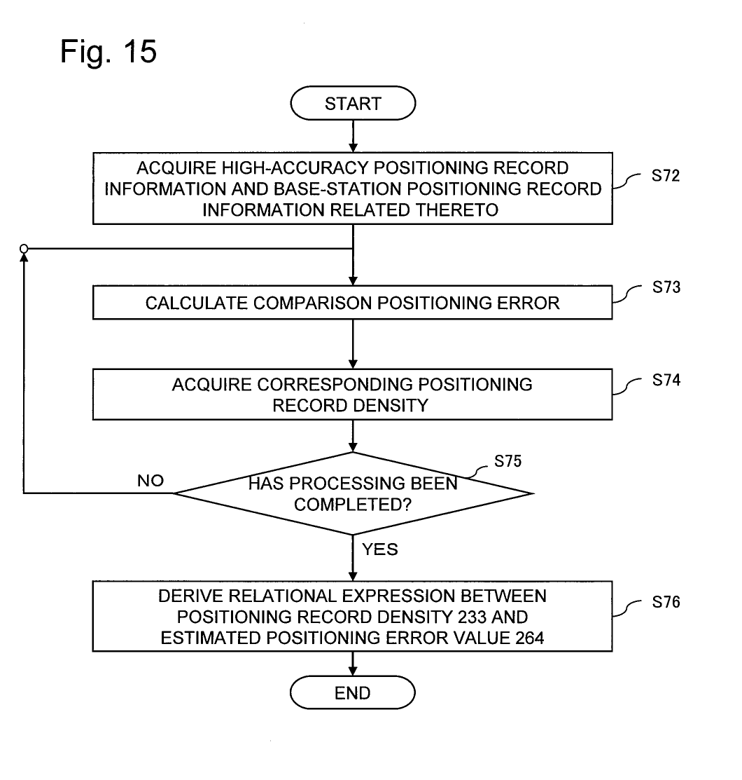

FIG. 15 is a flowchart illustrating operations of the density and positioning error function deriving phase, according to this exemplary embodiment.

First, the density and positioning error function derivation unit 29 acquires high-accuracy positioning record information from the high-accuracy positioning record storage unit 28. Subsequently, the density and positioning error function derivation unit 29 acquires base-station positioning record information related to the high-accuracy positioning record information from the record selection unit 24 (step S72).

The base-station positioning record information and the high-accuracy positioning record information related thereto has the same positioning time of day 164. That is, the base-station positioning record information and the high-accuracy positioning record information including the high-accuracy positioning result information 160 and a certain piece of the base-station positioning result information 169, these pieces of information having been acquired during the same positioning phase, respectively. Hereinafter, the high-accuracy positioning record information and the base-station positioning record information related thereto will be collectively referred to as a related positioning record.

Next, acquired, the density and positioning error function derivation unit 29 calculates a comparison positioning error regarding the acquired related positioning record (step S73). Specifically, the density and positioning error function derivation unit 29 calculates the comparison positioning error on the basis of a distance having been calculated from the latitude 141 and the longitude 142 included in the high-accuracy positioning result information 160 and the latitude 121 and the longitude 122 included in the base-station positioning result information 169 of the related positioning record (the distance being a direct distance between a spot specified by the latitude 141 and the longitude 142 and a spot specified by the latitude 121 and the longitude 122). For example, the density and positioning error function derivation unit 29 may handle the distance as the comparison positioning error as it is.

Next, the density and positioning error function derivation unit 29 acquires the positioning record density 233 corresponding to the related positioning record from the positioning record density calculation unit 23 (step S74). Specifically, the density and positioning error function derivation unit 29 provides the positioning record density calculation unit 23 with the latitude 141 and the longitude 142 indicated by the high-accuracy positioning record information of the related positioning record. The positioning record density calculation unit 23, which has received the latitude 141 and the longitude 142, calculates the positioning record density 233 in accordance with the procedure having been described in the first exemplary embodiment. Next, the positioning record density calculation unit 23 returns the calculated positioning record density 233 to the density and positioning error function derivation unit 29. For example, the positioning record density 233 is calculated as the number of pieces of positioning record information per a unit area of the corresponding place 231, the number thereof being obtained as the result of dividing the positioning record information accumulated number 232 at the corresponding place 231 including a position based on the corresponding high-accuracy positioning result 140 by the area of the corresponding place 231.

In this way, the density and positioning error function derivation unit 29 acquires the positioning record density 233 and the comparison positioning error, which are correlated with each other, regarding the related positioning record.

Next, the density and positioning error function derivation unit 29 confirms whether the processing for acquiring the positioning record density 233 and the comparison positioning error, which are correlated with each other, has been completed regarding each of all the related positioning records, or not (step S75). Further, if the processing has not been completed regarding each of all the related positioning records (‘NO’ in step S75), the process flow returns to step S73. In contrast, if the processing has been completed regarding each of all the related positioning records (‘YES’ in step S75), the process flow proceeds to step S76.

In step S76, the density and positioning error function derivation unit 29 derives a relational expression between the positioning record density 233 and the estimated positioning error value 264 on the basis of the positioning record densities 233 and the comparison positioning errors, these two kinds of information being correlated with each other. Subsequently, the density and positioning error function derivation unit 29 transmits the derived relational expression to the density and positioning error calculation unit 25 (step S76). For example, on the basis of the plurality of positioning record densities 233 and the plurality of comparison positioning errors, these two kinds of information being correlated with each other, the density and positioning error function derivation unit 29 derives a relational expression between the positioning record density 233 and the estimated positioning error value 264 by a function approximation method using a least square method.

In addition, regarding the function approximation method may employ an interpolation for making errors at sample points be zero, a min-max approximation for making a maximum value of the absolute values of errors be minimum, or the like.

The density and positioning error function derivation unit 29 derives, for example, the following expression.

Estimated positioning error value=a×Positioning record density+b

Specifically, supposing that a basis function is a linear function on a coordinate system having an axis indicating the values of the comparison positioning error, and an axis indicating the values of the positioning record density 233, the density and positioning error function derivation unit 29 determines the ‘a’ and ‘b’, which are to be fixed numbers, by the above-described function approximation, on the basis of the plurality of comparison positioning errors and the plurality of positioning record densities 233, these two kinds of information being correlated with each other. In addition, it is supposed that the basis function and the method of the function approximation to be used are determined in advance.

The advantageous effects of this exemplary embodiment described above are that, in addition to the advantageous effects of the first exemplary embodiment, it is possible to derive a relational expression capable of calculating the positioning error values more correctly.

The reason for this is that existing processing has been improved such that the following processes are involved. First, the density and positioning error function derivation unit 29 calculates comparison positioning errors from differences between positions specified by the latitudes and the longitudes included in the pieces of high-accuracy positioning record information, and positions specified by the latitudes and the longitudes included in the pieces of base-station positioning record information. Next, on the basis of the calculated comparison positioning errors and the positioning record densities, the density and positioning error function derivation unit 29 derives a relational expression between the positioning record density and the estimated positioning error value.

### Third Exemplary Embodiment

Next, a third exemplary embodiment according to the present invention will be described in detail with reference to the drawings. This exemplary embodiment is an exemplary embodiment resulting from causing the second exemplary embodiment to be configured more specifically. Hereinafter, contents overlapping with those of the description above will be omitted from description as far as the description of this exemplary embodiment does not become uncertain.

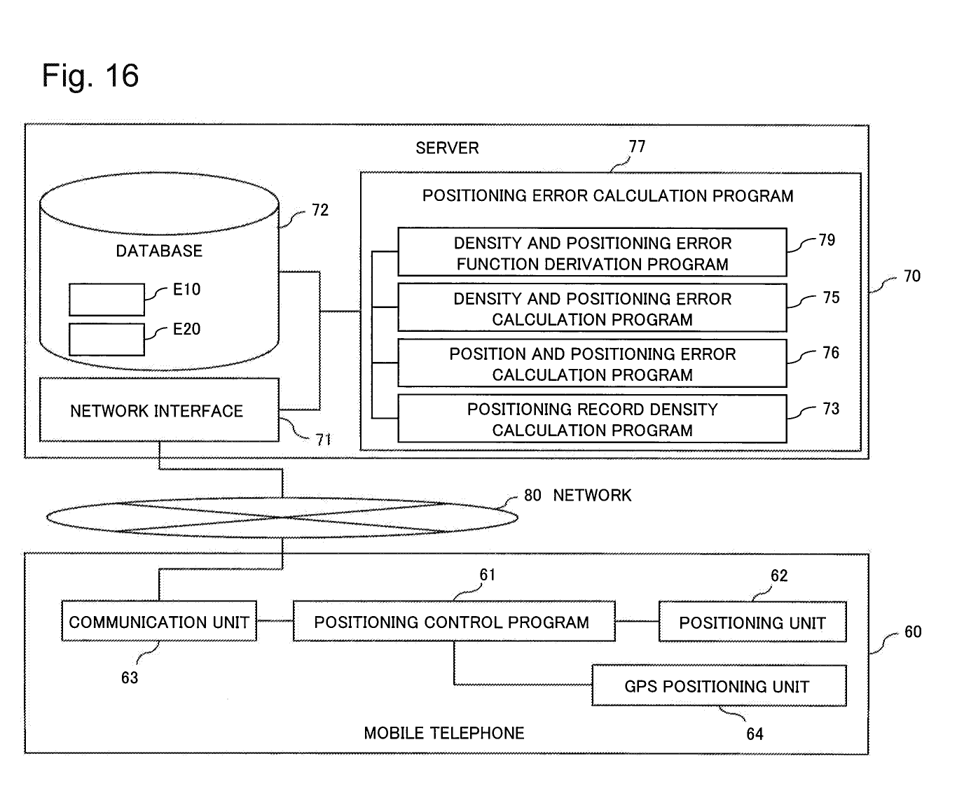

FIG. 16 is a block diagram illustrating a configuration of this exemplary embodiment. Referring to FIG. 16, in this exemplary embodiment, the terminal device 10, the positioning error calculation device 20 and the network 30 of the second exemplary embodiment are replaced by specific components, that is, a mobile telephone 60, a server 70 and a network (a mobile-telephone communication network and the Internet) 80, respectively.

The mobile telephone 60 includes a communication unit 63, a positioning unit 62, a GPS positioning unit 64 and a positioning control program 61 which correspond to the communication unit 13, the positioning unit 12, the high-accuracy positioning unit 14 and the positioning control unit 16 of the second exemplary embodiment, respectively. The communication unit 63 communicates through the network 80. The positioning unit 62 performs positioning through radio base stations. The GPS positioning unit 64 performs high-accuracy positioning. The positioning control program periodically operates.

Further, the server 70 includes a network interface 71 corresponding to the communication unit 21 of the second exemplary embodiment, and a database 72 corresponding to the positioning record storage unit 22 and the high-accuracy positioning record storage unit 28 of the second exemplary embodiment. The network interface 71 is connected to the network 80. The database 72 stores therein a base-station positioning result information table E10 and a high-accuracy positioning result information table E20. The server 70 further includes a positioning error calculation program (also referred to as a positioning error estimation program) 77 which causes a computer (not illustrated) inside the server to execute processing for calculating positioning errors.

The server 70 may be constituted by a computer including a CPU and a non-transitory storage medium. In this case, the server 70 causes the computer to execute predetermined processing by using a program.

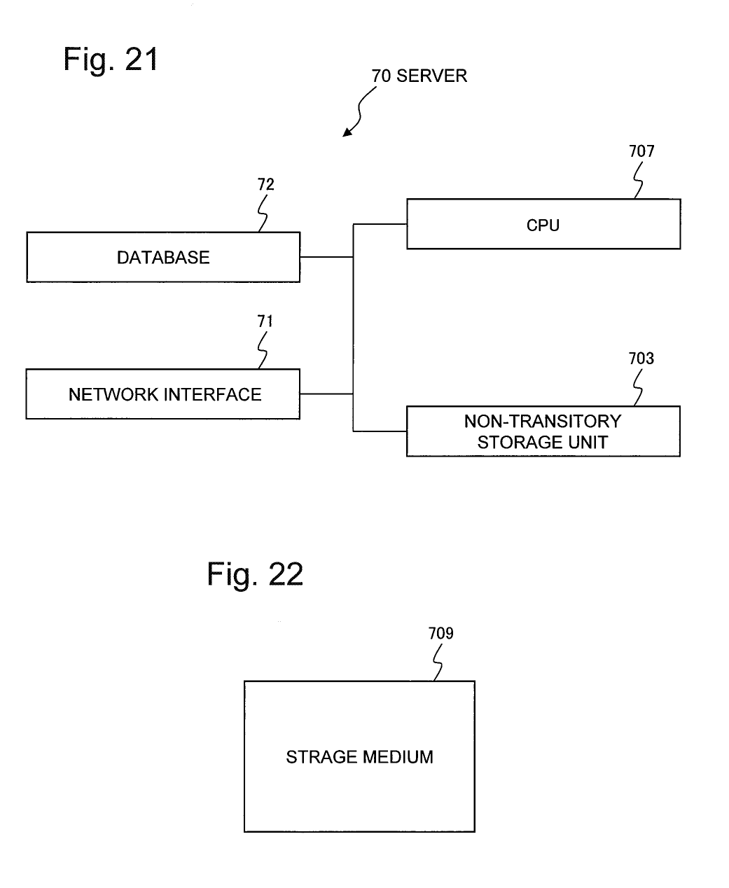

FIG. 21 is a diagram illustrating the server 70 which causes a computer to execute predetermined processing by using a program. Referring to FIG. 21, the server 70, which is constituted by a computer, includes the network interface 71, the database 72, a CPU 707 and a non-transitory storage unit 703.

The non-transitory storage device 703 stores therein the positioning error calculation program 77 including a positioning record density calculation program 73, a density and positioning error calculation program 75, a position and positioning error calculation program 76 and a density and positioning error function derivation calculation program 79, these programs described above being shown in FIG. 16.

The CPU 707 executes predetermined processing on the basis of the positioning error calculation program 77 stored in the non-transitory storage device 703.

The positioning error calculation program 77 includes the positioning record density calculation program 73 corresponding to the positioning record density calculation unit 23 and the record selection unit 24 of the second exemplary embodiment, and includes the density and positioning error calculation program 75, the position and positioning error calculation program 76 and the density and positioning error function derivation calculation program 79 corresponding to the density and positioning error calculation unit 25, the position and positioning error calculation unit 26 and the density and positioning error function derivation unit 29 of the second exemplary embodiment, respectively.

First, positioning processing will be described.

The positioning control program 61 of the mobile telephone 60 operates so as to alternately repeat positioning processing and staying in a dormant state such that, after having performed the positioning processing, the positioning control program transits into the dormant state and stays therein during a fixed period of time, and performs the positioning processing again after the elapse of the fixed period of time.

In the positioning processing, first, the positioning control program 61 calls a GPS positioning API (not illustrated), and receives the high-accuracy positioning result 140 shown in FIG. 11 as a response thereto. Here, it is supposed that the values of the latitude 141, the longitude 142 and the accuracy 143 included in the received high-accuracy positioning result 140 are, for example, N (North latitude) 35.642, E (East longitude) 139.752 and 5, respectively. In addition, the unit of each of the latitude and the longitude is, for example, degrees, and the unit of the accuracy is, for example, meters.

Next, the positioning control program 61 calls a base-station positioning API (not illustrated), and receives the base-station positioning result 129 shown in FIG. 9 as a response thereto. Here, it is supposed that the values of the latitude 121, the longitude 122 and the accuracy 123 included in the received base-station positioning result 129 are, for example, N 35.65, E 139.75 and 30000, respectively.

The positioning control program 61, which has acquired the high-accuracy positioning result 140 and the base-station positioning result 129, transmits these results to the server 70. In addition, when transmitting the high-accuracy positioning result 140 to the server 70, the positioning control program 61 adds the positioning time of day 164 and the high-accuracy positioning result information identifier 165 to the high-accuracy positioning result 140, and thereby creates the high-accuracy positioning result information 160 shown in FIG. 12. Next, the positioning control program 61 transmits the created high-accuracy positioning result information 160 to the server 70. Further, when transmitting the base-station positioning result 129 to the server 70, the positioning control program 61 adds the positioning time of day 164 and the base-station positioning result information identifier 167 to the base-station positioning result information 149, and thereby creates the base-station positioning result information 169 shown in FIG. 10. Next, the positioning control program 61 transmits the created base-station positioning result information 169 to the server 70.

The positioning error calculation program 77 of the server 70 receives the high-accuracy positioning result information 160 and the base-station positioning result information 169 via the network interface 71.

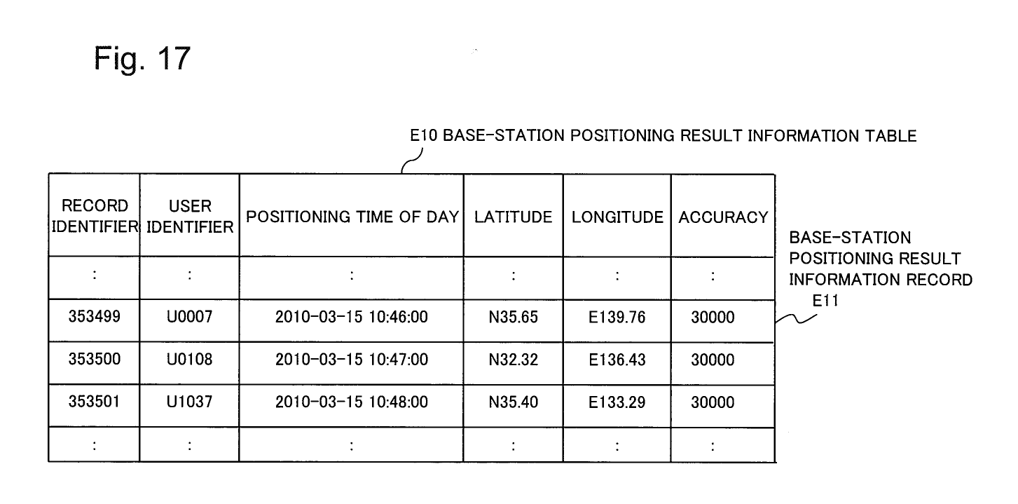

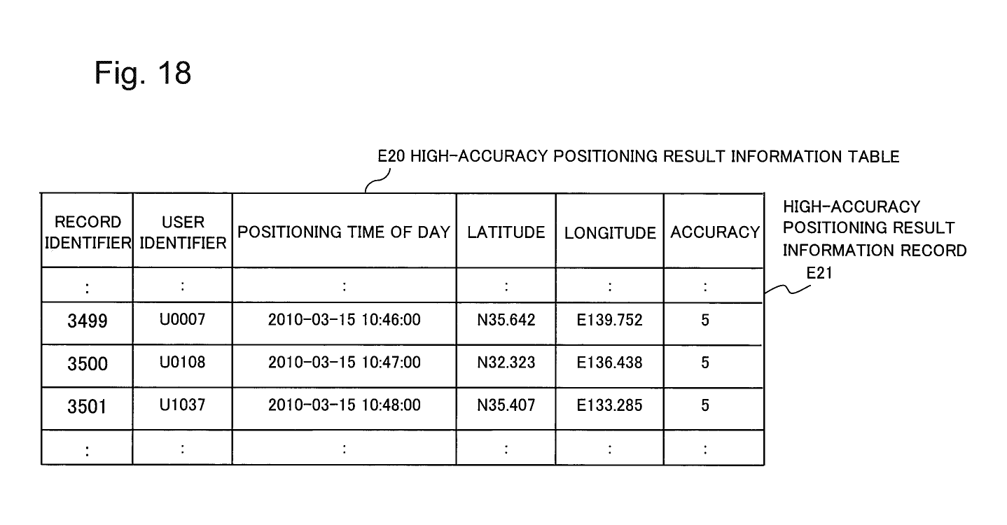

The positioning error calculation program 77, which has received the high-accuracy positioning result information 160, stores the high-accuracy positioning result information 160 into the high-accuracy positioning result information table E20, shown in FIG. 18, inside the database 72 as the high-accuracy positioning record information, on the basis of the high-accuracy positioning result information identifier 165. Further, the positioning error calculation program 77, which has received the base-station positioning result information 169, stores the base-station positioning result information 169 into the base-station positioning result information table E10, shown in FIG. 17, inside the database 72 as the base-station positioning record information, on the basis of the base-station positioning result information identifier 167.

FIG. 17 is a diagram illustrating an example of the base-station positioning result information table E10. The base-station positioning result information table E10 is a table for storing therein the base-station positioning result information 169 as the base-station positioning record information. As shown in FIG. 17, the base-station positioning result information table E10 has at least one base-station positioning result information record E11 (the base-station positioning record information) including a record identifier, a user identifier, the positioning time of day 164, the latitude 121, the longitude 122 and the accuracy 123.

FIG. 18 is a diagram illustrating an example of the high-accuracy positioning result information table E20. The high-accuracy positioning result information table E20 is a table for storing therein the high-accuracy positioning result information 160 as the high-accuracy positioning record information. As shown in FIG. 18, the high-accuracy positioning result information table E20 has at least one high-accuracy positioning result information record E21 (the high-accuracy positioning record information) including a record identifier, a user identifier, the positioning time of day 164, the latitude 141, the longitude 142 and the accuracy 143.

In addition, the base-station positioning result information table E10 and the high-accuracy positioning result information table E20 may be consolidated into one table such that a base-station positioning result information identifier 167 and a high-accuracy positioning result information identifier 165 are added to each piece of the base-station positioning result information 169 and each piece of the high-accuracy positioning result information 160, respectively.

For example, the base-station positioning result information record E11 included in the base-station positioning result information table E10 is one of records each storing therein the corresponding piece of base-station positioning record information. In this case, the base-station positioning result information record E11 indicates that the latitude 121, the longitude 122 and the accuracy 123 are N 35.65, E 139.76 and 30000, respectively. The high-accuracy positioning result information record E21 included in the high-accuracy positioning result information table E20 is one of records each storing therein the corresponding piece of high-accuracy positioning record information. In this case, the high-accuracy positioning result information record E21 indicates that the latitude 141, the longitude 142 and the accuracy 143 are N 35.642, E 139.752 and 5, respectively.

With the completion of the above-described processes, the positioning processing terminates.

Next, processing for calculating comparison positioning errors will be specifically described.

The positioning record density calculation program 73 periodically operates.

The positioning record density calculation program 73 acquires base-station positioning record information falling within a predetermined fixed period of time from the database 72.

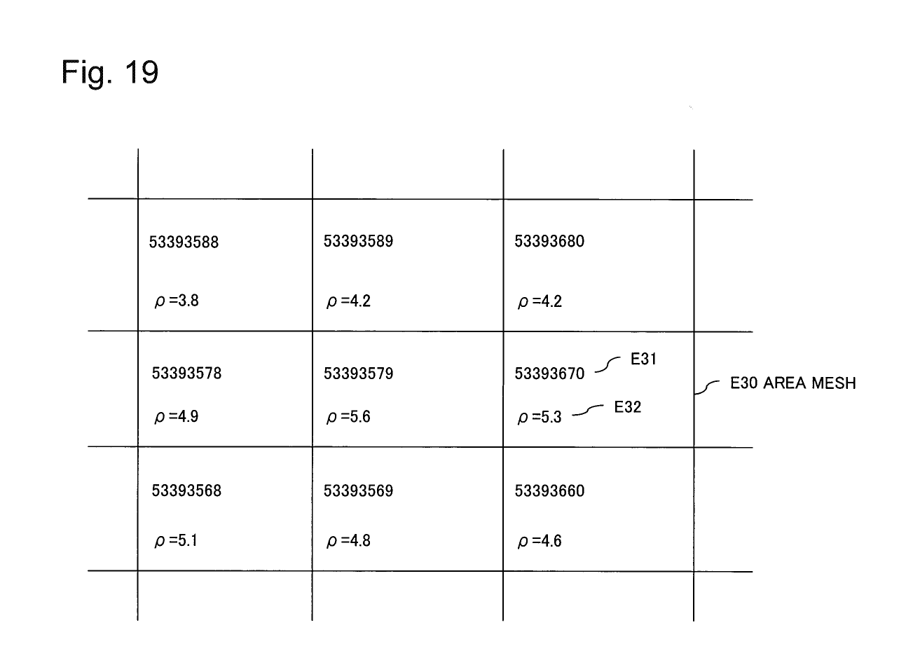

Next, the positioning record density calculation program 73 sorts the acquired base-station positioning record information by each of area meshes E30 (the places 231) shown in FIG. 19. Next, the positioning record density calculation program 73 calculates the number of records (the number of the pieces of positioning record information) corresponding to each of the area meshes E30.

FIG. 19 is a diagram schematically illustrating relations among the area meshes E30, area-mesh codes E31, and positioning record densities ρ E32 (the positioning record densities 233) having been calculated for the respective area meshes E30. In FIG. 19, for example, it is shown that the positioning record density ρ E32 corresponding to the area mesh E30 which is specified by the area-mesh code E31 ‘53393670’ is 5.3.

For example, a record indicated by a row corresponding to a record identifier ‘353499’ of the base-station positioning result information record E11 included in the base-station positioning result information table E10 has a latitude and a longitude included in one of the area meshes E30 (area divisions), which is specified by the area-mesh code E31 (for example, ‘53393670’). Therefore, the positioning record density calculation program 73 increments the number of records by one, which corresponds to the area mesh E30 having the area-mesh code E31 ‘53393670’, as processing on the base-station positioning result information record E11 corresponding to the row which is included in the base-station positioning result information table E10, and which has the record identifier ‘353499’.

Further, the positioning record density calculation program 73 converts the number of the records, which corresponds to each of the area meshes E30, into the number of records per a unit time, and thereby calculates the positioning record densities ρ E32. Next, the positioning record density calculation program 73 provides the position and positioning error calculation program 76 with the calculated positioning record densities ρ E32.

Next, the density and positioning error function derivation program 79 acquires the high-accuracy positioning record information falling within a predetermined fixed period of time. Here, it is supposed that the density and positioning error function derivation program 79 has acquired a piece of high-accuracy positioning record information stored in the high-accuracy positioning result information record E21 whose record identifier is 3499.

Next, the density and positioning error function derivation program 79, which has acquired the piece of high-accuracy positioning record information, acquires a corresponding piece of base-station positioning record information, that is, a piece of base-station positioning record information stored in the base-station positioning result information record E11 whose record identifier is 353499.

Next, the density and positioning error function derivation program 79 calculates a difference between two spots specified by corresponding latitudes and longitudes, that is, a distance between the two spots (for example, 1.1 km) on the basis of the piece of high-accuracy positioning record information and the piece of base-station positioning record information which have been acquired above. Further, the density and positioning error function derivation program 79 determines that a comparison positioning error at the spot whose latitude and longitude are N 35.642 N and E 139.57, respectively, is, for example, 1.1 kilometers by using the calculated distance as it is.

Next, the density and positioning error function derivation program 79 derives a relational expression between the positioning record density ρ E32 and the estimated positioning error value 264 on the basis of the positioning record densities ρ E32 at the respective area meshes, which have been calculated by the positioning record density calculation program 73, and the comparison positioning errors at respective spots.

For example, the density and positioning error function derivation program 79 creates values 5.3 and 1.1 kilometers as the positioning record density ρ E32 and a sample value of the comparison positioning error, respectively, on the basis of the situation that the positioning record density ρ E32 corresponding to the area mesh E30 including the spot whose latitude and longitude are N 35.642 and E 139.752, respectively, is 5.3.

In this way, for each of all the comparison positioning errors, the density and positioning error function derivation program 79 creates a sample value thereof which is combined with the corresponding positioning record density ρ E32.

Further, the density and positioning error function derivation program 79 derives a relational expression between the positioning record density ρ E32 and the estimated positioning error value 264 on the basis of the created sample values.

The density and positioning error function derivation program 79 derives a relational expression which can be applied to each of all the area meshes E30 by using all the sample values.

Further, the density and positioning error function derivation program 79 may derive a relational expression which can be applied to one or more specific ones of the area meshes E30 by using sample values corresponding to the respective specific ones of the area meshes E30.

Moreover, the density and positioning error function derivation program 79 may derive a relational expression which can be applied to a specific one of the area meshes E30 by using sample values, on each of which weighting is performed in accordance with a distance from the specific one of the area meshes E30 to a certain one of the area meshes E30, which corresponds to the each of the sample values.

As a result of the operations described above, the density and positioning error function derivation program 79 derives, for example, the following relational expression.

f(ρ)=0.5+0.15ρ (f(ρ): Estimated positioning error value)

The position and the positioning error calculation program 76 provides a density and positioning error calculation request including the positioning record densities ρ E32, which correspond to the respective area meshes E30, and which have been acquired from the positioning record density calculation program 73 to the density and the positioning error calculation program 75.

Next, the density and the positioning error calculation program 75 converts the positioning record densities ρ E32, which are included in the received density and positioning error calculation request, in accordance with the relational expression having been derived by the density and positioning error function derivation program 79, and thereby calculates the estimated positioning error values 264. Further, the density and the positioning error calculation program 75 provides the position and the positioning error calculation program 76 with the estimated positioning error values 264 having been calculated above.

In this way, the position and the positioning error calculation program 76, which has acquired the estimated positioning error values 264, acquires the estimated positioning error values 264 corresponding to the respective area meshes E30 (the places 231) which have the corresponding positioning record densities 233. For example, a value of 1.3 kilometers is acquired as the estimated positioning error value 264 corresponding to the area mesh E30 whose area-mesh code E31 is 53393670.

This exemplary embodiment described above has the same advantageous effects as those of the second exemplary embodiment.

The reason for this is that existing processing has been improved such that the following processes are involved. First, the positioning record density calculation program 73 calculates the positioning record densities p at the respective places on the basis of the accumulated pieces of positioning record information. Next, from correlations between the record densities and estimated positioning error values, the density and the positioning error calculation program 75 calculates the estimated positioning error values at the respective places.

### Fourth Exemplary Embodiment

Next, a fourth exemplary embodiment according to the present invention will be described in detail with reference to the drawings. This exemplary embodiment is an exemplary embodiment including only basic components according to the present invention. Hereinafter, contents overlapping with those of the description above will be omitted from description as far as the description of this exemplary embodiment does not become uncertain.

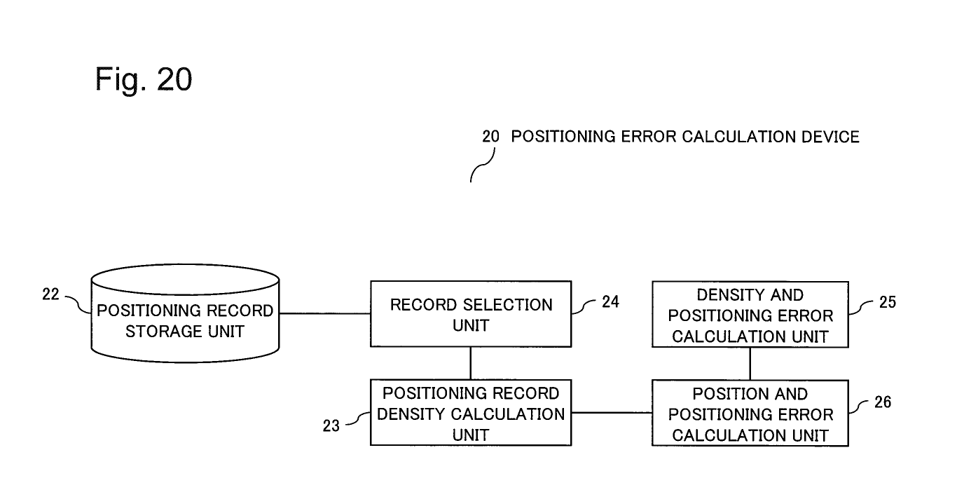

FIG. 20 is a block diagram illustrating a configuration of this fourth exemplary embodiment according to the present invention. Referring to FIG. 20, the positioning error calculation device 20 according to this fourth exemplary embodiment includes the positioning record storage unit 22, the record selection unit 24, the positioning record density calculation unit 23, the density and positioning error calculation unit 25 and the position and positioning error calculation unit 26.

The positioning record storage unit 22 stores therein first positioning record information including the positioning result information 110 corresponding the positions of terminal devices, having been measured by first positioning units. The record selection unit 24 selects and acquires first positioning record information conforming to a predetermined condition from the positioning record storage unit 22.

The positioning record density calculation unit 23 calculates the positioning record densities 233 at the respective predetermined places 231 on the basis of the first positioning record information having been acquired by the record selection unit 24.

The density and positioning error calculation unit 25 calculates the estimated positioning error values 264 by using a predetermined relational expression, on the basis of the positioning record densities 233 having been calculated by the positioning record density calculation unit 23.

On the basis of the positioning record densities 233 having been calculated by the positioning record density calculation unit 23, the position and positioning error calculation unit 26 acquires the estimated positioning error values 264 corresponding to the respective places 231 from the density and positioning error calculation unit 25, and handles them as the estimated positioning error values 264 at the respective places 231.

The advantageous effect of this exemplary embodiment described above is that it is possible to provide appropriate positioning error values regarding corresponding pieces of position data obtained by base-station positioning.

The reason for this is that existing processing has been improved such that the following processes are involved. First, the positioning record density calculation unit 23 calculates the positioning record densities at the respective places by referring to the accumulated positioning record information. Next, the density and positioning error calculation unit 25 calculates the estimated positioning error values corresponding to the respective places by calculating the estimated positioning error values on the basis of the positioning record densities corresponding to the respective places; thereby enabling improvement of existing processing.

In addition, the positioning error calculation device 20 having been described in the first exemplary embodiment and the fourth exemplary embodiment, as well as in the second exemplary embodiment, may be constituted by the computer including the CPU and the non-transitory storage medium, which have been described in the third exemplary embodiment. In this case, the record selection unit 24, the positioning record density calculation unit 23, the density and positioning error calculation unit 25 and the position and positioning error calculation unit 26, which are shown in FIGS. 1 and 20, correspond to a CPU 707 and a non-transitory storage device 703 shown in FIG. 21. The communication unit 21 shown in Fig. corresponds to a network interface 71. The positioning record storage unit 22 shown in FIGS. 1 and 20 corresponds to a database 72 shown in FIG. 21.

It is not necessarily that each of the components having been described in the individual exemplary embodiments above is an individually independent entity. For example, each of the components may be configured such that a plurality of components may be realized as one module, or a certain component may be realized by a plurality of modules. Further, each of the components may be also configured such that a certain component is part of another component, or part of a certain component and part of another component are overlapped by each other.

Moreover, in each of the exemplary embodiments having been described above, a plurality of operations is described in a corresponding order by using the form of a flowchart, but the order of the descriptions does not limit any order in which the plurality of operations is performed. Therefore, when any of the exemplary embodiments is carried out, the order of the plurality of operations can be changed as far as the contents of the individual operations are left untouched.

Moreover, in each of the exemplary embodiments having been described above, the plurality of operations is not limited to a procedure in which the operations are to be performed during individually different pieces of timing. For example, while a certain operation is performed, another operation may occur, or the execution timing of a certain operation and that of another operation may be partially or entirely overlapped by each other.

Moreover, in each of the exemplary embodiments having been described above, there are some descriptions each suggesting that a certain operation is to be a trigger of another operation, but any of such descriptions does not limit all relations between certain operations and another operations. Therefore, when any of the exemplary embodiments is carried out, relations among the plurality of operations can be changed as far as the contents of the operations are left untouched. Furthermore, the specific descriptions on operations of the respective components do not limit the operations of the respective components. Therefore, when any of the exemplary embodiments is carried out, the specific operations of the respective components can be changed within a scope leaving the characteristics thereof untouched in the aspects of functionality, performance and the like.

In addition, each of the components of the individual exemplary embodiments described above may be realized by hardware, software or a mixture of hardware and software in accordance with necessity if the realization thereby is possible.

Further, the physical configuration of each of the components is not limited to the descriptions of the exemplary embodiments above, and each of the components may be physically configured so as to exist in an independent state, in a combined state or in a separate state.

Part of or the whole of the exemplary embodiments described above can be also described as the following supplementary notes, but is not limited to them.

### (Supplementary Note 1)

A positioning error calculation method including:

storing first positioning result information corresponding to a position of a terminal device, the position having been estimated by a first positioning unit, into a first positioning record storage unit;

selecting and acquiring the required first positioning record information from the first positioning record storage unit;

calculating a density of positioning records at each of predetermined places on the basis of the first positioning record information having been acquired;

calculating an estimated positioning error value on the basis of the density having been calculated;

acquiring the estimated positioning error value at each of the places by, for each of the places, acquiring the corresponding estimated positioning error value on the basis of the calculated density at the each of the places to acquire the estimated positioning error value corresponding to the density;

storing second positioning record information including second positioning result information corresponding to a position of the terminal device, the position having been measured by a second positioning unit, into a second positioning record storage unit; and

deriving a relational expression for calculating the estimated positioning error value on the basis of the first positioning record information and the second positioning record information, wherein

the relational expression is derived on the basis of at least one group of the density, and a comparison positioning error which is calculated on the basis of position information based on the second positioning record information and position information based on the first positioning record information corresponding to the second positioning record information.

### (Supplementary Note 2)

The positioning error calculation method according to supplementary note 1, wherein the relational expression which can be applied to each of all the places is derived by using each of all the at least one group of the density and the comparison error.

### (Supplementary Note 3)

The positioning error calculation method according to supplementary note 1, wherein the relational expression which can be applied to specific at least one of the places is derived by using at least one group of the density and the comparison positioning error, the at least one group corresponding to the specific at least one of the places.

### (Supplementary Note 4)

The positioning error calculation method according to supplementary note 1, wherein the relational expression which can be applied to a specific one of the places is derived by performing weighting on the comparison positioning error in accordance with a distance from the specific one of the places to a certain one of the places which is related to the comparison positioning error having been subjected to weighting, and using a group of the density and the comparison positioning error having been subjected to weighting.

### (Supplementary Note 5)

A non-transitory medium for recording a positioning error calculation program which causes a computer to execute processing, the processing including: a process of selecting and acquiring the first positioning record information from among first positioning result information which is stored in a first positioning record storage unit, and which corresponds to a position of a terminal device, having been measured by a first positioning unit;

a process of calculating a density of positioning records at each of predetermined places on the basis of the first positioning record information having been acquired;

a process of calculating an estimated positioning error value on the basis of the density having been calculated;

a process of acquiring the estimated positioning error value at each of the places by, for each of the places, acquiring the corresponding estimated positioning error value on the basis of the calculated density at the each of the places to acquire the estimated positioning error value corresponding to the density; and

a process of deriving a relational expression for calculating the estimated positioning error value on the basis of the first positioning record information and second positioning result information which is stored in a second positioning record storage unit, and which corresponds to a position of the terminal device, having been measured by a second positioning unit.

### (Supplementary Note 6)

The non-transitory medium for recording a positioning error calculation program, according to supplementary note 5, wherein, in the process of deriving the relational expression, the relational expression which can be applied to each of all the places by using each of all groups of the density and the comparison error.

### (Supplementary Note 7)

The non-transitory medium for recording a positioning error calculation program, according to supplementary note 5, wherein, in the process of deriving the relational expression, the relational expression which can be applied to specific at least one of the places is derived by using at least one group of the density and the comparison positioning error, the at least one group corresponding to the specific at least one of the places.

### (Supplementary Note 8)

The non-transitory medium for recording a positioning error calculation program, according to supplementary note 5, wherein, in the process of deriving the relational expression, the relational expression which can be applied to a specific one of the places is derived by performing weighting on the comparison positioning error in accordance with a distance from the specific one of the places to a certain one of the places, which corresponds to the comparison positioning error having been subjected to weighting, and using a group of the density and the comparison positioning error having been subjected to weighting.

### (Supplementary Note 9)

A positioning error calculation system including a terminal device and a positioning error calculation device,

wherein the terminal device includes a first communication unit;

a first positioning unit which performs positioning of the terminal device itself; and

a positioning control unit which acquires first positioning result from the first positioning unit, and outputs first positioning result information on the basis of the first acquisition result, and

the first communication unit transmits the first positioning result information to the positioning error calculation device, and

wherein the positioning error calculation device includes

a second communication unit which receives the first positioning result information;

a first positioning record storage unit which stores therein first positioning record information including the positioning result information;

a record selection unit which selects and acquires the first positioning record information from the first positioning record storage unit;

a positioning record density calculation unit which calculates a density of positioning records at each of predetermined places on the basis of the first positioning record information having been acquired by the record selection unit;

a density and positioning error calculation unit which calculates an estimated positioning error value on the basis of the density having been calculated by the positioning record density calculation unit; and

a position and positioning error calculation unit which acquires the estimated positioning error value at each of the places by acquiring the estimated positioning error value corresponding to the density from the density and positioning error calculation unit on the basis of the density at the each of said places, having been calculated by the positioning record density calculation unit.

### (Supplementary Note 10)

The positioning error calculation system according to supplementary note 9, wherein the terminal device further includes a second positioning unit which performs positioning of a position of the terminal device itself,

wherein, in the terminal device, the positioning control unit acquires a second positioning result from the second positioning unit, and outputs second positioning result information on the basis of the second acquisition result, and the first communication unit transmits the second positioning result information to the positioning error calculation device,

wherein, in the positioning error calculation device, the second communication unit receives the second positioning result information, and

wherein the positioning error calculation device further includes a second positioning record storage unit which stores therein second positioning record information including the second positioning result information corresponding to a position of the terminal device, having been measured by the second positioning unit, and a density and positioning error relational expression derivation unit which derives a relational expression for calculating the estimated positioning error value on the basis of the first positioning record information and the second positioning record information.

### (Supplementary Note 11)

The positioning error calculation system according to supplementary note 10, wherein the density and positioning error relational expression derivation unit calculates a comparison positioning error on the basis of position information based on the second positioning record information and position information based on the first positioning record information corresponding to the second positioning record information, and derives the relational expression on the basis of at least one group of the density and the comparison error.

### (Supplementary Note 12)

The positioning error calculation system according to supplementary note 10, wherein the density and positioning error function derivation unit derives the relational expression which can be applied to each of all the places, by using each of all the at least one group of the density and the comparison error.

### (Supplementary Note 13)

The positioning error calculation system according to supplementary note 11, wherein the density and positioning error function derivation unit derives the relational expression which can be applied to specific at least one of the places, by using at least one group of the density and the comparison positioning error, the at least one group corresponding to the specific at least one of the places.

### (Supplementary Note 14)

The positioning error calculation system according to supplementary note 11, wherein the density and positioning error function derivation unit derives the relational expression which can be applied to a specific one of the places, by performing weighting on the comparison positioning error in accordance with a distance from the specific one of the places to a certain one of the places, which corresponds to the comparison positioning error having been subjected to weighting, and using a group of the density and the comparison positioning error having been subjected to weighting.

### (Supplementary Note 15)

A positioning error calculation device including:

a first positioning record storage unit which stores therein first positioning record information including first positioning result information corresponding to a position of a terminal device, having been estimated by a first positioning unit;

a record selection unit which selects and acquires the first positioning record information from the first positioning record storage unit;

a positioning record density calculation unit which calculates a density of positioning records at each of predetermined places on the basis of the first positioning record information having been acquired by the record selection unit;

a density and positioning error calculation unit which calculates an estimated positioning error value on the basis of the density having been calculated by the positioning record density calculation unit; and

a position and positioning error calculation unit which acquires the estimated positioning error value at each of the places by acquiring the estimated positioning error value corresponding to the density from the density and positioning error calculation unit on the basis of the density at the each of the places, having been calculated by the positioning record density calculation unit.

### (Supplementary Note 16)

The positioning error calculation device according to supplementary note 15, further including:

a second positioning record storage unit which stores therein second positioning record information including second positioning result information corresponding to a position of the terminal device, having been measured by a second positioning unit; and

a density and positioning error relational expression derivation unit which derives a relational expression for calculating the estimated positioning error value on the basis of the first positioning record information and the second positioning record information.

### (Supplementary Note 17)

The positioning error calculation device according to supplementary note 16, wherein the density and positioning error relational expression derivation unit calculates a comparison positioning error on the basis of position information based on the second positioning record information and position information based on the first positioning record information corresponding to the second positioning record information, and derives the relational expression on the basis of at least one group of the density and the comparison error.

### (Supplementary Note 18)

The positioning error calculation device according to supplementary note 17, wherein the density and positioning error function derivation unit derives the relational expression which can be applied to each of all the places, by using each of all the at least one group of the density and the comparison error.

### (Supplementary Note 19)

The positioning error calculation device according to supplementary note 17, wherein the density and positioning error function derivation unit derives the relational expression which can be applied to specific at least one of the places, by using at least one group of the density and the comparison positioning error, the at least one group corresponding to the specific at least one of the places.

### (Supplementary Note 20)

The positioning error calculation device according to supplementary note 17, wherein the density and positioning error function derivation unit derives the relational expression which can be applied to a specific one of the places, by performing weighting on the comparison positioning error in accordance with a distance from the specific one of the places to a certain one of the places, which corresponds to the comparison positioning error having been subjected to weighting, and using a group of the density and the comparison positioning error having been subjected to weighting.

### (Supplementary Note 21)

A positioning error calculation method including:

storing first positioning result information corresponding to a position of a terminal device, which has been measured by a first positioning unit, into a first positioning record storage unit;

selecting and acquiring the first positioning record information from the first positioning record storage unit;

calculating a density of positioning records at each of predetermined places on the basis of the first positioning record information having been acquired;

calculating an estimated positioning error value on the basis of the density having been calculated; and

acquiring the estimated positioning error value at each of the places by acquiring the estimated positioning error value corresponding to the density on the basis of the density at the each of the places, having been calculated.

### (Supplementary Note 22)

The positioning error calculation method according to supplementary note 21, further including:

storing second positioning record information including second positioning result information corresponding to a position of the terminal device, having been measured by a second positioning unit, and

deriving the relational expression for calculating the estimated positioning error value on the basis of the first positioning record information and the second positioning record information.

### (Supplementary Note 23)

A non-transitory medium for recording a positioning error calculation program which causes a computer to execute processing, the processing including:

a process of selecting and acquiring first positioning record information conforming to a predetermined condition from among first positioning result information which is stored in a first positioning record storage unit, and which corresponds to a position of a terminal device, having been measured by a first positioning unit;

a process of calculating a density of positioning records at each of predetermined places on the basis of the first positioning record information having been acquired;

a process of calculating an estimated positioning error value on the basis of the density having been calculated; and

a process of acquiring the estimated positioning error value at each of the places by acquiring the estimated positioning error value corresponding to the density on the basis of the density at the each of the places, having been calculated.

### (Supplementary Note 24)

The non-transitory medium, according to supplementary note 23, for recording a positioning error calculation program which causes a computer to execute processing, the processing further including:

a process of deriving the relational expression for calculating the estimated positioning error value on the basis of the first positioning record information and second positioning result information which is stored in a second positioning record storage unit, and which corresponds to a position of the terminal device, having been measured by a second positioning unit.

Hereinbefore, the present invention has been described with reference to the exemplary embodiments thereof, but the present invention is not limited to these exemplary embodiments. Various changes, which can be understood by those skilled in the art, can be made on the configuration and the details of the present invention within the scope not departing from the gist of the present invention.

This application is based upon and claims the benefit of priority from Japanese Patent Application No. 2010-141339, filed on Jun. 22, 2010, the disclosure of which is incorporated herein in its entirety by reference.

### INDUSTRIAL APPLICABILITY

The present invention can be applied to devices, systems and the like related to services utilizing position information.

### DESCRIPTION OF THE REFERENCE NUMERALS

10 Terminal device
11 Positioning control unit
12 Positioning unit
13 Communication unit
14 High-accuracy positioning unit
16 Positioning control unit
20 Positioning error calculation device
21 Communication unit
22 Positioning record storage unit
23 Positioning record density calculation unit
24 Record selection unit
25 Density and positioning error calculation unit
26 Position and positioning error calculation unit
28 High-accuracy positioning record storage unit
29 Density and positioning error function derivation unit
30 Network
60 Mobile telephone
61 Positioning control program
62 Positioning unit
63 Communication unit
64 GPS positioning unit
70 Server
71 Network interface
72 Database
73 Positioning record density calculation program
75 Positioning error calculation program
76 Positioning error calculation program
77 Positioning error calculation program
79 Positioning error function derivation program
80 Network
110 Positioning result information
114 Positioning time of day
120 Positioning result
123 Accuracy
129 Base-station positioning result
140 High-accuracy positioning result
143 Accuracy
149 Base-station positioning result information
160 High-accuracy positioning result information
164 Positioning time of day
165 High-accuracy positioning result information identifier
167 Base-station positioning result information identifier
169 Base-station positioning result information
230 Positioning density table
231 Place
232 Positioning record information accumulated number
233 Positioning record density
239 Positioning density record
260 Position and positioning error table
264 Estimated positioning error value
269 Position and positioning error record
703 Non-transitory storage unit
707 CPU
E10 Base-station positioning result information table
E11 Base-station positioning result information record
E20 High-accuracy positioning result information table
E21 High-accuracy positioning result information record
E30 Area mesh
E31 Area-mesh code
E32 Positioning record density ρ

1. A positioning error calculation device comprising:
first positioning record storage unit which stores therein first positioning record information including first positioning result information corresponding to a position of a terminal device, having been estimated by first positioning unit;
record selection unit which selects and acquires said first positioning record information from said first positioning record storage unit;
positioning record density calculation unit which calculates a density of positioning records at each of predetermined places on the basis of said first positioning record information having been acquired by said record selection unit;
density and positioning error calculation unit which calculates an estimated positioning error value on the basis of said density having been calculated by said positioning record density calculation unit; and
position and positioning error calculation unit which acquires said estimated positioning error value at each of said places by acquiring said estimated positioning error value corresponding to said density from said density and positioning error calculation unit on the basis of said density at the each of said places, having been calculated by said positioning record density calculation unit.

2. The positioning error calculation device according to claim 1, further comprising:
second positioning record storage unit which stores therein second positioning record information including second positioning result information corresponding to a position of said terminal device, having been measured by second positioning unit; and
density and positioning error relational expression derivation unit which derives a relational expression for calculating said estimated positioning error value on the basis of said first positioning record information and said second positioning record information.

3. The positioning error calculation device according to claim 2, wherein said density and positioning error relational expression derivation unit calculates a comparison positioning error on the basis of position information based on said second positioning record information and position information based on said first positioning record information corresponding to said second positioning record information, and derives said relational expression on the basis of at least one group of said density and said comparison positioning error.

4. The positioning error calculation device according to claim 3, wherein said density and positioning error relational expression derivation unit derives said relational expression which can be applied to each of all said places, by using each of all said at least one group of said density and said comparison positioning error.

5. The positioning error calculation device according to claim 3, wherein said density and positioning error relational expression derivation unit derives said relational expression which can be applied to specific at least one of said places, by using at least one group of said density and said comparison positioning error, the at least one group corresponding to the specific at least one of said places.

6. The positioning error calculation device according to claim 3, wherein said density and positioning error relational expression derivation unit derives said relational expression which can be applied to a specific one of said places, by performing weighting on said comparison positioning error in accordance with a distance from the specific one of said places to a certain one of said places, which corresponds to the said comparison positioning error, and using a group of said density and the said comparison positioning error having been subjected to weighting.

7. A positioning error calculation method comprising:
Storing first positioning record information including first positioning result information corresponding to a position of a terminal device, which has been measured by first positioning means, into first positioning record storage means;
selecting and acquiring said first positioning record information from said first positioning record storage means;
calculating a density of positioning records at each of predetermined places on the basis of said first positioning record information having been acquired;
calculating an estimated positioning error value on the basis of said density having been calculated; and
acquiring said estimated positioning error value at each of said places by acquiring said estimated positioning error value corresponding to said density on the basis of said density at the each of said places, having been calculated.

8. The positioning error calculation method according to claim 7, further comprising:
storing second positioning record information including second positioning result information corresponding to a position of said terminal device, having been measured by second positioning means, and
deriving a relational expression for calculating said estimated positioning error value on the basis of said first positioning record information and said second positioning record information.

9. A non-transitory computer-readable recording medium for recording a positioning error calculation program which causes a computer to execute processing, the processing comprising:
a process of selecting and acquiring first positioning record information conforming to a predetermined condition from among the first positioning record information including first positioning result information which is stored in first positioning record storage means, and which corresponds to a position of a terminal device, having been measured by first positioning means;
a process of calculating a density of positioning records at each of predetermined places on the basis of said first positioning record information having been acquired;
a process of calculating an estimated positioning error value on the basis of said density having been calculated; and
a process of acquiring said estimated positioning error value at each of said places by acquiring said estimated positioning error value corresponding to said density on the basis of said density at the each of said places, having been calculated.

10. The non-transitory computer-readable recording medium, according to claim 9, for recording a positioning error calculation program which causes a computer to execute processing, the processing further comprising:
a process of deriving a relational expression for calculating said estimated positioning error value on the basis of said first positioning record information and second positioning result information which is stored in second positioning record storage means, and which corresponds to a position of said terminal device, having been measured by second positioning means.
